(19) United States
(12) Patent Application Publication
(10) Pub. No.: US 2026/0323176 A1
(43) Pub. Date: Oct. 15, 2026

(54) IMAGING DEVICE

(71) Applicant: SONY SEMICONDUCTOR SOLUTIONS CORPORATION, KANAGAWA (JP)

(72) Inventors: TAKAYA YAMANAKA, KANAGAWA (JP); RYO FUKUI, KANAGAWA (JP)

(21) Appl. No.: 19/486,147

(22) PCT Filed: Dec. 19, 2023
(86) PCT No.: PCT/JP2023/045504

§ 371 Date: Nov. 20, 2025

(30) Foreign Application Priority Data
Jun. 9, 2023 (JP) 2023-095670
Jul. 6, 2023 (JP) 2023-111331

(51) Int. Cl. H04N 25/585; H04N 25/771; H04N 25/78

(52) U.S. Cl. CPC H04N 25/585; H04N 25/771; H04N 25/78

(57) ABSTRACT

To suppress deterioration in image quality due to dielectric absorption of a capacitor used for a charge accumulation unit.

An imaging device includes: a photoelectric conversion unit; a capacitor having one end connected to the photoelectric conversion unit; a first transistor having one end connected to the capacitor and the other end connected to a first node; a second transistor having one end connected to the first node and the other end connected to a power supply; and a control unit that controls driving of the first transistor and the second transistor. The control unit turns on the first transistor and the second transistor in at least a part of a period from a read operation of reading a pixel voltage of the first node to a shutter operation of the photoelectric conversion unit.

### TECHNICAL FIELD

The present technology relates to an imaging device. Specifically, the present technology relates to an imaging device provided with a charge accumulation unit.

### BACKGROUND ART

In order to expand the dynamic range of imaging, an overflow accumulation capacitor that accumulates charge overflowing from a photodiode is sometimes used. For example, an imaging device provided with a first switch that connects a first light receiving element and a first charge accumulation unit and a second switch that connects a second light receiving element and a second charge accumulation unit has been proposed (see, for example, Patent Document 1).

### CITATION LIST

### Patent Document

Patent Document 1: WO 2019/82614 A.

### SUMMARY OF THE INVENTION

### Problems to be Solved by the Invention

However, in the above-described conventional technology, when a high dielectric capacitor is used for the charge accumulation unit, there is a possibility that an afterimage and deterioration of linearity are caused due to dielectric absorption of the high dielectric capacitor.

The present technology has been made in view of such a situation, and an object thereof is to suppress deterioration in image quality due to dielectric absorption of a capacitor used for a charge accumulation unit.

### Solutions to Problems

The present technology has been made to solve the above-described problem, and a first aspect thereof is an imaging device including: a photoelectric conversion unit; a capacitor having one end connected to the photoelectric conversion unit; a first transistor having one end connected to the capacitor and the other end connected to a first node; a second transistor having one end connected to the first node and the other end connected to a power supply; and a control unit that controls driving of the first transistor and the second transistor, in which the control unit turns on the first transistor and the second transistor in at least a part of a period from a read operation of reading a pixel voltage of the first node to a shutter operation of the photoelectric conversion unit. This brings about an effect that the voltage applied to the capacitor is controlled so that a voltage is not applied to the capacitor before an accumulation period in which charge is accumulated in the photoelectric conversion unit.

Furthermore, in the first aspect, the control unit may control a voltage applied to the capacitor so that a voltage is not applied to the capacitor before an accumulation period in which charge is accumulated in the photoelectric conversion unit. This brings about an effect that control is performed so that charge is not accumulated in the capacitor before an accumulation period in which charge is accumulated in the photoelectric conversion unit.

Furthermore, in the first aspect, the capacitor may include a high dielectric capacitor. This brings about an effect that the capacitance of the capacitor is increased without increasing the size of the capacitor.

Furthermore, in the first aspect, the capacitor may accumulate charge overflowing from the photoelectric conversion unit. This brings about an effect of expanding the dynamic range of imaging.

Furthermore, in the first aspect, the control unit may read a signal from the capacitor on the basis of double data sampling (DDS) driving. This brings about an effect that the charge overflowed from the photoelectric conversion unit is read out.

Furthermore, in the first aspect, the other end of the capacitor may be connected to a control power supply, and a potential of the control power supply may be set to an intermediate potential lower than a potential of the power supply in an accumulation period. This brings about an effect that the dark current of the capacitor is reduced in the accumulation period.

Furthermore, in the first aspect, the photoelectric conversion unit may include a first photoelectric conversion unit and a second photoelectric conversion unit having lower sensitivity than the first photoelectric conversion unit; and the capacitor may accumulate charge overflowing from the second photoelectric conversion unit. This brings about an effect of expanding the dynamic range of imaging.

Furthermore, in the first aspect, the capacitor may have a three-dimensional metal insulation metal (MIM) structure. This brings about an effect that the capacitance of the capacitor is increased without increasing the planar size of the capacitor.

Furthermore, in the first aspect, the control unit may turn on the first transistor and the second transistor in an entire period from a read operation of reading a pixel voltage of the first node to a shutter operation of the photoelectric conversion unit. This brings about an effect that charge accumulated in the capacitor before the accumulation period in which charge is accumulated in the photoelectric conversion unit is discharged.

Furthermore, in the first aspect, the control unit may turn on the first transistor and the second transistor from the middle of a period from a read operation of reading a pixel voltage of the first node to a shutter operation of the photoelectric conversion unit. This brings about an effect that the charge accumulated in the capacitor is discharged before the accumulation period in which charge is accumulated in the photoelectric conversion unit while shortening the period in which a high voltage is applied to the floating diffusion connected to the capacitor.

Furthermore, in the first aspect, the control unit may intermittently turn on the first transistor and the second transistor in a period from a read operation of reading a pixel voltage of the first node to a shutter operation of the photoelectric conversion unit. This brings about an effect that the charge accumulated in the capacitor is discharged before the accumulation period in which charge is accumulated in the photoelectric conversion unit while the shutter step can be suppressed.

Furthermore, a second aspect is an imaging device including: a photoelectric conversion unit; a first transistor having one end connected to the photoelectric conversion unit and the other end connected to a first node; a second transistor having one end connected to the first node and the other end connected to a second node; a third transistor having one end connected to the second node and the other end connected to a power supply; a capacitor connected to the second node; and a control unit that controls driving of the first transistor, the second transistor, and the third transistor, in which the control unit turns on the third transistor in at least a part of an accumulation period in the photoelectric conversion unit. This brings about an effect that the capacitor is reset in an accumulation period in which charge is accumulated in the photoelectric conversion unit.

Furthermore, in the second aspect, the control unit may turn on the first transistor and turn off the second transistor when turning on the third transistor in at least a part of the accumulation period in the photoelectric conversion unit. This brings about an effect that the capacitor is reset in the accumulation period while increasing the capacitance of the floating diffusion capable of accumulation in the accumulation period.

In addition, in the second aspect, the capacitor may include a high dielectric capacitor. This brings about an effect that the capacitance of the capacitor is increased without increasing the size of the capacitor.

Furthermore, in the second aspect, a gate voltage applied to the second transistor may be made variable. This brings about an effect that the capacitor is reset in the accumulation period while increasing the capacitance of the floating diffusion capable of accumulation in the accumulation period.

Furthermore, in the second aspect, a capacitor connected to the first node and not affected by dielectric absorption may be further included. This brings about an effect that the capacitor is reset in the accumulation period while increasing the capacitance of the first node.

Furthermore, in the second aspect, the first transistor may include an embedded gate. This brings about an effect that the capacitor is reset in the accumulation period while increasing the gate capacitance of the first transistor.

### BRIEF DESCRIPTION OF DRAWINGS

FIG. 1 is a block diagram illustrating a configuration example of an imaging device according to a first embodiment.

FIG. 2 is a block diagram illustrating a configuration example of a solid-state imaging device according to the first embodiment.

FIG. 3 is a diagram illustrating a circuit configuration example of a pixel provided in the solid-state imaging device according to the first embodiment.

FIG. 4 is a cross-sectional view illustrating a capacitor configuration example applied to the solid-state imaging device according to the first embodiment.

FIG. 5 is a timing chart illustrating an example of a relationship between a read operation and a shutter operation of the solid-state imaging device according to the first embodiment.

FIG. 6 is a timing chart illustrating an example of waveforms of units in a read operation, a shutter operation, and an accumulation operation of the solid-state imaging device according to the first embodiment.

FIG. 7 is a timing chart illustrating an example of waveforms of units in a read operation, a shutter operation, and an accumulation operation of a solid-state imaging device according to a second embodiment.

FIG. 8 is a timing chart illustrating an example of waveforms of units in a read operation, a shutter operation, and an accumulation operation of a solid-state imaging device according to a third embodiment.

FIG. 9 is a diagram illustrating a circuit configuration example of a pixel provided in a solid-state imaging device according to a fourth embodiment.

FIG. 10 is a diagram illustrating an example of potentials in a pre-accumulation period and an accumulation period of the solid-state imaging device according to the fourth embodiment.

FIG. 11 is a timing chart illustrating an example of waveforms of units in a read operation, a shutter operation, and an accumulation operation of the solid-state imaging device according to the fourth embodiment.

FIG. 12 is a diagram illustrating a circuit configuration example of a pixel provided in a solid-state imaging device according to a fifth embodiment.

FIG. 13 is a timing chart illustrating an example of waveforms of units in a read operation, a shutter operation, and an accumulation operation of the solid-state imaging device according to the fifth embodiment.

FIG. 14 is a diagram illustrating a circuit configuration example of a pixel provided in a solid-state imaging device according to a sixth embodiment.

FIG. 15 is a diagram illustrating a circuit configuration example of a pixel provided in a solid-state imaging device according to a seventh embodiment.

FIG. 16 is a timing chart illustrating an example of a relationship between a read operation and a shutter operation of the solid-state imaging device according to the seventh embodiment.

FIG. 17 is a diagram illustrating a first example of potentials of a vertical blanking period and an accumulation period of the solid-state imaging device according to the seventh embodiment.

FIG. 18 is a diagram illustrating the first example of potentials of the vertical blanking period and the accumulation period of the solid-state imaging device according to the seventh embodiment.

FIG. 19 is a diagram illustrating the first example of potentials of the vertical blanking period and the accumulation period of the solid-state imaging device according to the seventh embodiment.

FIG. 20 is a diagram illustrating a second example of potentials of the vertical blanking period and the accumulation period of the solid-state imaging device according to the seventh embodiment.

FIG. 21 is a diagram illustrating the second example of potentials of the vertical blanking period and the accumulation period of the solid-state imaging device according to the seventh embodiment.

FIG. 22 is a diagram illustrating a third example of potentials of the vertical blanking period and the accumulation period of the solid-state imaging device according to the seventh embodiment.

FIG. 23 is a diagram illustrating the third example of potentials of the vertical blanking period and the accumulation period of the solid-state imaging device according to the seventh embodiment.

FIG. 24 is a diagram illustrating an example of potentials in an accumulation period of a solid-state imaging device according to an eighth embodiment.

FIG. 25 is a diagram illustrating a circuit configuration example of a pixel provided in a solid-state imaging device according to a ninth embodiment.

FIG. 26 is a cross-sectional view illustrating a configuration example of a pixel provided in a solid-state imaging device according to a 10th embodiment.

FIG. 27 is a perspective view illustrating a lamination example of a pixel array unit according to an 11th embodiment.

FIG. 28 is a block diagram illustrating a schematic configuration example of a vehicle control system.

FIG. 29 is an explanatory diagram illustrating an example of an installation position of an imaging section.

### MODE FOR CARRYING OUT THE INVENTION

Modes for carrying out the present technology (hereinafter referred to as embodiments) will be described below. The description will be given in the following order.
1. First embodiment (an example in which a reset transistor and a pass transistor are turned on in an entire period from a read operation to a shutter operation in a pixel provided with photodiodes having different sensitivities).
2. Second embodiment (an example in which a reset transistor and a pass transistor are turned on from the middle of a period from a read operation to a shutter operation in a pixel provided with photodiodes having different sensitivities).
3. Third embodiment (an example in which a reset transistor and a pass transistor are intermittently turned on in a period from a read operation to a shutter operation in a pixel provided with photodiodes having different sensitivities).
4. Fourth embodiment (an example in which a reset transistor and a pass transistor are turned on in a period from a read operation to a shutter operation in a pixel in which photodiodes having different sensitivities are provided and transfer transistors are connected to the photodiodes.)
5. Fifth embodiment (an example in which a reset transistor and a pass transistor are turned on in a period between a read operation and a shutter operation in a pixel provided with a photodiode and a lateral overflow integration capacitor (LOFIC)).
6. Sixth embodiment (an example in which reset transistor and pass transistor are turned on in a period between a read operation and a shutter operation in a pixel in which an overflow control transistor is provided between a photodiode and a lateral overflow integration capacitor).
7. Seventh embodiment (an example in which a capacitor is reset in an accumulation period).
8. Eighth embodiment (an example in which a gate voltage of a pass transistor is made variable in an accumulation period).
9. Ninth embodiment (an example in which a capacitor not affected by dielectric absorption is added).
10. 10th embodiment (an example in which an embedded gate is provided in a switching transistor).
11. 11th embodiment (an example in which a pixel array unit is laminated).
12. Example of application to mobile body.

### 1. First Embodiment

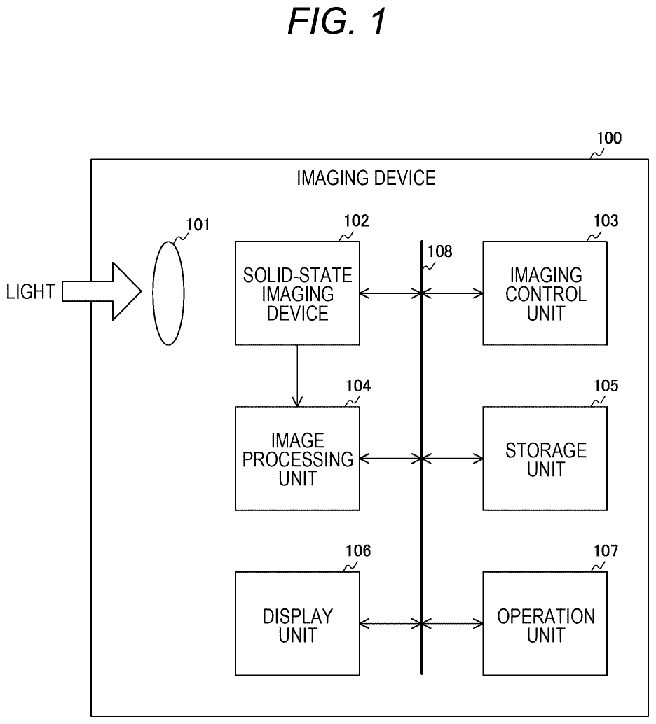

FIG. 1 is a diagram illustrating a configuration example of an imaging device according to a first embodiment.

In the drawing, an imaging device 100 includes an optical system 101, a solid-state imaging device 102, an imaging control unit 103, an image processing unit 104, a storage unit 105, a display unit 106, and an operation unit 107. The imaging control unit 103, the image processing unit 104, the storage unit 105, the display unit 106, and the operation unit 107 are interconnected via a bus 108. Note that the imaging device 100 may be used alone, may be incorporated in a portable terminal such as a smartphone, may be incorporated in an authentication device or a monitoring device, may be incorporated in an authentication device or a monitoring device, or may be incorporated in a vehicle or a drone.

The optical system 101 causes light from a subject to enter the solid-state imaging device 102, and forms an optical image on a light-receiving surface of the solid-state imaging device 102. The optical system 101 can include, for example, a focus lens, a zoom lens, a diaphragm, and the like. The optical system 101 may include a plurality of lenses such as a wide-angle lens, a standard lens, and a telephoto lens.

The solid-state imaging device 102 converts light from the optical image formed on the light-receiving surface into an electric signal for each pixel, and digitizes and outputs the electric signal. The solid-state imaging device 102 is, for example, a complementary metal oxide semiconductor (CMOS) image sensor. The CMOS image sensor may be a back-illuminated image sensor or a front-illuminated image sensor. Note that the application of the present technology is not limited to the solid-state imaging device 102, and the present technology may be applied to a light detection device such as a time of flight (ToF) sensor or an event detection sensor.

The imaging control unit 103 controls the imaging by the solid-state imaging device 102 on the basis of a command from the operation unit 107. At this time, the imaging control unit 103 can control the exposure time, the exposure amount, the imaging timing, and the like of the solid-state imaging device 102.

The image processing unit 104 performs image processing on the basis of the output from the solid-state imaging device 102. The image processing is, for example, gamma correction, white balance processing, sharpness processing, or gradation conversion processing. The image processing unit 104 may include a processor that executes processing on the basis of software.

The storage unit 105 stores a captured image captured by the solid-state imaging device 102, and stores imaging parameters and the like of the solid-state imaging device 102. Furthermore, the storage unit 105 can store a program for operating the imaging device 100 on the basis of software. The storage unit 105 may include a read only memory (ROM), a random access memory (RAM), and a memory card.

The display unit 106 displays a captured image and displays various types of information supporting the imaging operation. The display unit 106 may be a liquid crystal display or an organic electro luminescence (EL) display.

The operation unit 107 provides a user interface for operating the imaging device 100. The operation unit 107 may include, for example, a button, a dial, and a switch provided in the imaging device 100. The operation unit 107 may be implemented as a touch panel integrated with the display unit 106.

Note that depending on the form of the imaging device 100, some of the above-described functions may be omitted, or conversely, functions that are not disclosed may be further included.

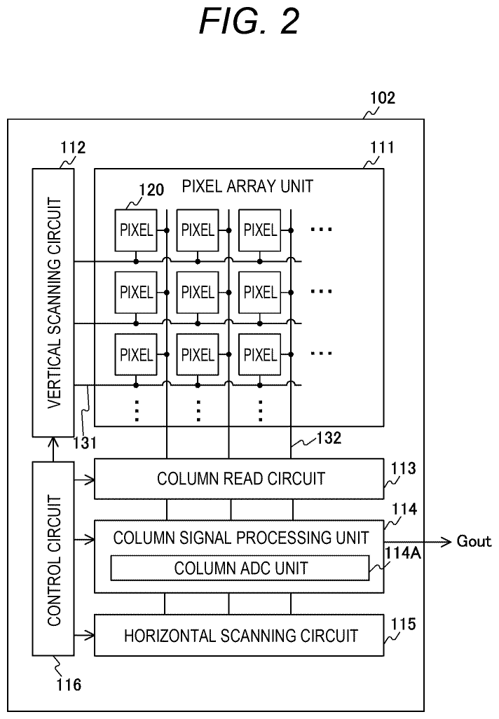

FIG. 2 is a block diagram illustrating a configuration example of the solid-state imaging device according to the first embodiment.

In FIG. 2, the solid-state imaging device 102 includes a pixel array unit 111, a vertical scanning circuit 112, a column read circuit 113, a column signal processing unit 114, a horizontal scanning circuit 115, and a control circuit 116.

The pixel array unit 111 includes a plurality of pixels 120. The pixels 120 are arranged in a matrix along a row direction (also referred to as a horizontal direction) and a column direction (also referred to as a vertical direction). Each pixel 120 includes a capacitor that accumulates charge overflowing from the photodiode. This capacitor may be a lateral overflow integration capacitor. Each pixel 120 may include a plurality of photodiodes having different sensitivities. Furthermore, each pixel 120 can form a source follower with the column read circuit 113 at the time of signal readout. Each pixel 120 is connected to a horizontal drive line 131 for each row, and is connected to a vertical signal line 132 for each column. When reading a signal from each pixel 120, the horizontal drive line 131 drives the pixels 120 for each row. The vertical signal line 132 transmits potentials based on currents flowing at the time of signal reading from the pixels 120 to the column signal processing unit 114 for each column.

The vertical scanning circuit 112 scans the pixels 120 to be read in the column direction. The vertical scanning circuit 112 may be configured using a vertical register.

The column read circuit 113 can form a source follower with each pixel 120 at the time of reading a signal from each pixel 120. At this time, the column read circuit 113 can change the potential of the vertical signal line 132 on the basis of the charge held in the pixel 120.

The column signal processing unit 114 processes a signal transmitted from each pixel 120 in the column direction. For example, the column signal processing unit 114 can perform correlated double sampling (CDS) processing on the basis of the signal transmitted from each pixel 120 in the column direction. Furthermore, the column signal processing unit 114 can perform analog to digital (AD) conversion processing on the basis of the signal transmitted from each pixel 120 in the column direction to output an imaging signal Gout.

The column signal processing unit 114 includes a column ADC unit 114A. The column ADC unit 114A can perform AD conversion processing in parallel for each column. At this time, the column ADC unit 114A can perform AD conversion for each column on the basis of a comparison result between a pixel signal read from the pixel 120 and a reference signal.

The horizontal scanning circuit 115 scans the pixels 120 to be read in the row direction. The horizontal scanning circuit 115 may be configured using a horizontal register.

The control circuit 116 controls the vertical scanning circuit 112, the column read circuit 113, the column signal processing unit 114, and the horizontal scanning circuit 115. For example, the control circuit 116 can control the scanning timing in the column direction, the scanning timing in the row direction, the operation timing of the column read circuit 113, and the processing timing of the column signal processing unit 114.

Furthermore, the control circuit 116 can control the voltage applied to the capacitor of each pixel 120 so that a voltage is not applied to the capacitor in a pre-accumulation period before an accumulation period in which charge is accumulated in the photodiode of each pixel 120. The pre-accumulation period can be set to at least a part of a period from a read operation of reading the pixel voltage from the pixel 120 to a shutter operation. Note that the control circuit 116 is an example of a control unit described in the claims.

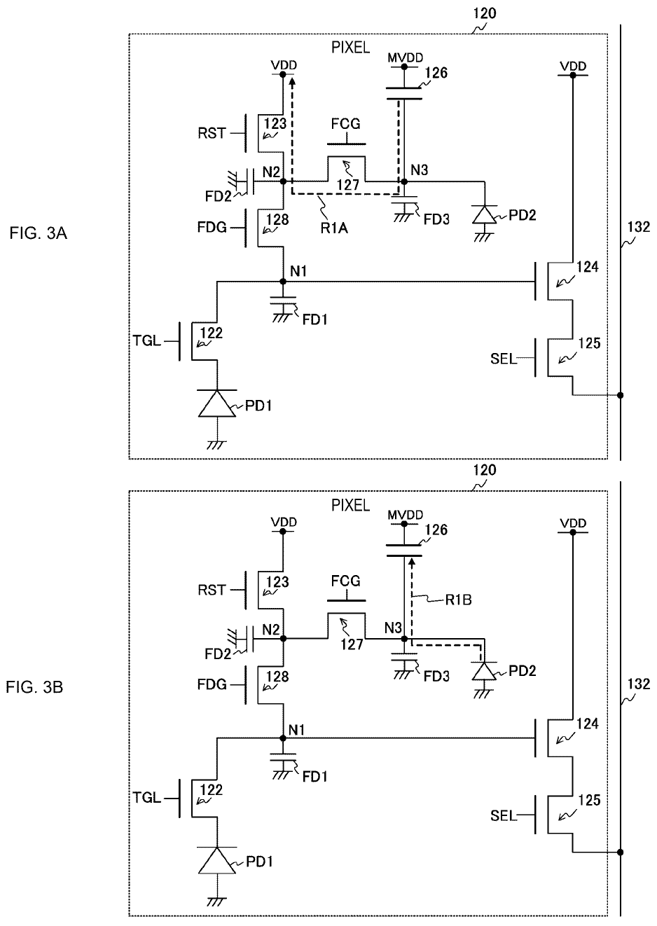

FIG. 3 is a diagram illustrating a circuit configuration example of the pixel provided in the solid-state imaging device according to the first embodiment.

In FIG. 3, the pixel 120 includes photodiodes PD1 and PD2, a transfer transistor 122, a reset transistor 123, an amplification transistor 124, a selection transistor 125, and floating diffusions FD1 to FD3. Furthermore, the pixel 120 includes a capacitor 126, a pass transistor 127, and a switching transistor 128. The transfer transistor 122, the reset transistor 123, the amplification transistor 124, the selection transistor 125, the pass transistor 127, and the switching transistor 128, may be metal oxide semiconductor (MOS) transistors. The capacitor 126 can use a metal insulation metal (MIM) capacitor. The capacitor 126 may be a three-dimensional MIM capacitor. Note that the pass transistor 127 is an example of a first transistor described in the claims. The reset transistor 123 is an example of a second transistor described in the claims.

Furthermore, nodes N1 to N3 are provided in the pixel 120. Floating diffusions FD1 to FD3 are formed in the nodes N1 to N3, respectively.

The photodiodes PD1 and PD2 perform photoelectric conversion and accumulate the photoelectrically converted charge. The photodiodes PD1 and PD2 have different sensitivities. At this time, the sensitivity of the photodiode PD2 can be made smaller than the sensitivity of the photodiode PD1. In order to make the sensitivity of the photodiode PD2 smaller than the sensitivity of the photodiode PD1, the plane size of the photodiode PD2 can be made smaller than the plane size of the photodiode PD1. Note that the photodiodes PD1 and PD2 are examples of a photoelectric conversion unit described in the claims.

The capacitor 126 accumulates charge overflowing from the photodiode PD2. The capacitor 126 may be shielded from light. One end of the capacitor 126 is connected to a control power supply voltage MVDD, and the other end of the capacitor 126 is connected to the node N3. In addition, the cathode of the photodiode PD2 is connected to the node N3. The capacitor 126 may be a high dielectric capacitor having a relative permittivity higher than a predetermined value (for example, 100).

The transfer transistor 122 transfers charge accumulated in the photodiode PD1 to the floating diffusion FD1. The reset transistor 123 resets the floating diffusions FD1 to FD3. The amplification transistor 124 outputs signals according to the potentials of the floating diffusions FD1 to FD3. The selection transistor 125 selects the output of the amplification transistor 124. The pass transistor 127 sets a path through which the charge accumulated in the capacitor 126 is transferred to the floating diffusion FD1. The switching transistor 128 switches the conversion efficiency in the amplification transistor 124.

The transfer transistor 122 is connected between the cathode of the photodiode PD1 and the node N1. The amplification transistor 124 and the selection transistor 125 are connected in series. The drain of the amplification transistor 124 is connected to a power supply voltage VDD. The gate of the amplification transistor 124 is connected to the node N1. The source of the selection transistor 125 is connected to the vertical signal line 132.

The pass transistor 127 is connected between the nodes N2 and N3. The switching transistor 128 is connected between the nodes N1 and N2. The reset transistor 123 is connected between the node N2 and the power supply voltage VDD. At this time, the reset transistor 123 and the switching transistor 128 are connected in series.

A transfer signal TGL is applied to the gate of the transfer transistor 122. A reset signal RST is applied to the gate of the reset transistor 123. A selection signal SEL is applied to the gate of the selection transistor 125. A pass setting signal FCG is applied to the gate of the pass transistor 127. A switching signal FDG is applied to the gate of the switching transistor 128. The transfer signal TGL, the reset signal RST, the selection signal SEL, the pass setting signal FCG, and the switching signal FDG can be transmitted to each pixel 120 via the horizontal drive line 131 in FIG. 2.

Here, in the pre-accumulation period, the voltage applied to the capacitor 126 is controlled so that no voltage is applied to the capacitor 126. At this time, as illustrated in a of FIG. 3, the reset signal RST and the pass setting signal FCG rise and the reset transistor 123 and the pass transistor 127 are turned on in at least a part of the period from the read operation of reading the pixel voltage from the pixel 120 to the shutter operation. At this time, the capacitor 126 is connected to the power supply voltage VDD via the reset transistor 123 and the pass transistor 127 (RIA). Moreover, the control power supply voltage MVDD can be set to the power supply voltage VDD. As a result, in the pre-accumulation period, the power supply voltage VDD is applied to both ends of the capacitor 126, and the voltage applied to the capacitor 126 is controlled so that no voltage is applied to the capacitor 126. Therefore, it is possible to prevent charge from being accumulated in the capacitor 126 before the start of the accumulation period, and it is possible to suppress potential fluctuation of the node N3 due to dielectric absorption of the capacitor 126. Note that turning on the transistor indicates a state in which the voltage applied to the terminal of the transistor exceeds a threshold voltage of the transistor. In addition, turning off the transistor indicates a state in which the voltage applied to the terminal of the transistor does not exceed the threshold voltage of the transistor, and conduction of a leakage current can be allowed even when the transistor is in an off state.

In the accumulation period, the capacitor 126 is set to the floating state. At this time, as illustrated in b of FIG. 3, the pass setting signal FCG falls after the shutter operation, and the pass transistor 127 is turned off. At this time, the capacitor 126 is disconnected from the power supply voltage VDD and is shifted to a floating state. When the capacitor 126 is shifted to the floating state, the charge having overflowed from the photodiode PD2 is accumulated in the capacitor 126 (RIB).

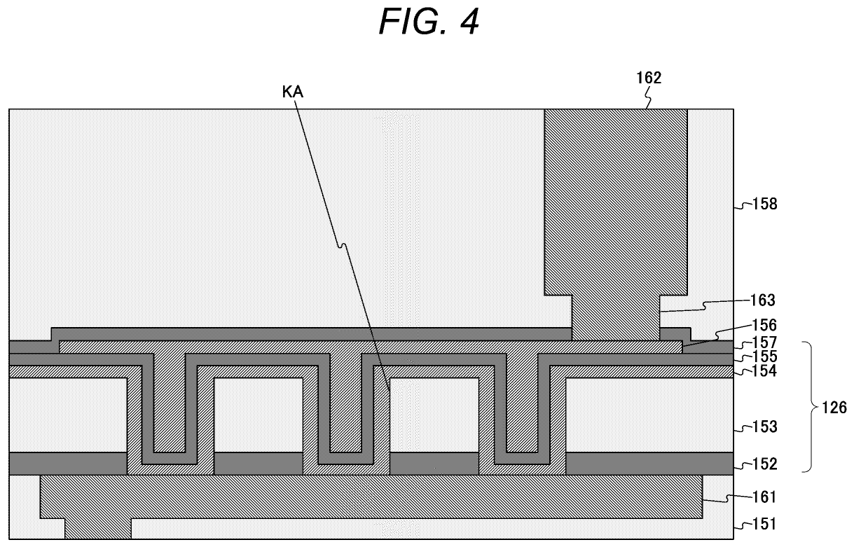

FIG. 4 is a cross-sectional view illustrating a capacitor configuration example applied to the solid-state imaging device according to the first embodiment. Note that in the drawings used in the following description, a scale, a shape, and the like may be different from an actual structure in order to facilitate understanding of each configuration.

In FIG. 4, a wiring layer 161 is embedded in an interlayer insulating layer 151. A passivation layer 152 is laminated on the wiring layer 161, and an interlayer insulating layer 153 is laminated on the passivation layer 152.

An opening KA for exposing the wiring layer 161 is formed in the passivation layer 152 and the interlayer insulating layer 153. A capacitive electrode 154 is formed on the interlayer insulating layer 153 so as to cover a bottom surface and a side surface of the opening KA. On the capacitive electrode 154, a dielectric layer 155 is formed so as to cover a bottom surface and a side surface of the capacitive electrode 154. On the dielectric layer 155, a capacitive electrode 156 is formed so as to cover a bottom surface and a side surface of the dielectric layer 155. The capacitive electrodes 154 and 156 and the dielectric layer 155 can be used as the capacitor 126. At this time, the capacitor 126 can constitute a three-dimensional MIM. On the dielectric layer 155, a passivation layer 157 is formed so as to cover the capacitive electrode 156. An interlayer insulating layer 158 is laminated on the passivation layer 157. A wiring layer 162 is embedded in the interlayer insulating layer 158. The wiring layer 162 is connected to the capacitive electrode 156 via a via 163.

As the materials of the wiring layers 161 and 162, the via 163, and the capacitive electrodes 154 and 156, for example, Cu, Ti, Ta, Al, W, Ni, Ru, Co, TiN, TaN, or WN can be used, and a laminated structure of a plurality of materials may be used.

As the material of the dielectric layer 155, for example, SiO₂, SiON, Si₃N₄, hafnium oxide (HfO₂), aluminum oxide (Al₂O₃), zirconium oxide (ZrO), tantalum oxide (Ta₂O₅), titanium oxide (TiO₂), lanthanum oxide (LaO₃), yttrium oxide (Y₂O₃), aluminum nitride (AlN), hafnium oxynitride (HfON), or aluminum oxynitride (AlON), can be used, and a laminated structure of a plurality of materials may be used.

As the materials of the interlayer insulating layers 151 and 158, for example, an inorganic material such as SiO₂, SiON, SiOC, Si₃N₄, or SiCO, or an organic material having a skeleton of polyimide, acrylic, silicone, or an epoxy group can be used, and a laminated Structure of a plurality of materials may be used.

As the materials of the passivation layers 152 and 157, an organic material having a skeleton of polyimide, acrylic, silicone, or an epoxy group, or a material containing a filler such as SiO₂, Al₂O₃, AlN, or BN can be used. The passivation layers 152 and 157 may be chemical vapor deposition (CVD) films or sputtered films.

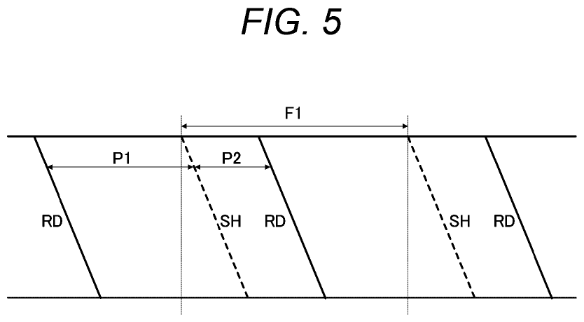

FIG. 5 is a timing chart illustrating an example of a relationship between a read operation and a shutter operation of the solid-state imaging device according to the first embodiment.

In FIG. 5, the solid-state imaging device repeats a shutter operation SH for each frame F1. At this time, the solid-state imaging device performs a read operation RD between the shutter operations SH in each frame F1.

Here, an accumulation period P2 is set in a period from the shutter operation SH to the read operation RD of each frame F1. In addition, a pre-accumulation period P1 is set in a period from the read operation RD to the shutter operation SH of the next frame F1.

In the pre-accumulation period P1, the voltage applied to the capacitor 126 is controlled so that no voltage is applied to the capacitor 126. As illustrated in a of FIG. 3, the reset transistor 123 and the pass transistor 127 are turned on in at least a part of the period from the read operation RD to the shutter operation SH.

In the accumulation period P2, the capacitor 126 is set to the floating state. At this time, as illustrated in b of FIG. 3, the pass transistor 127 is turned off.

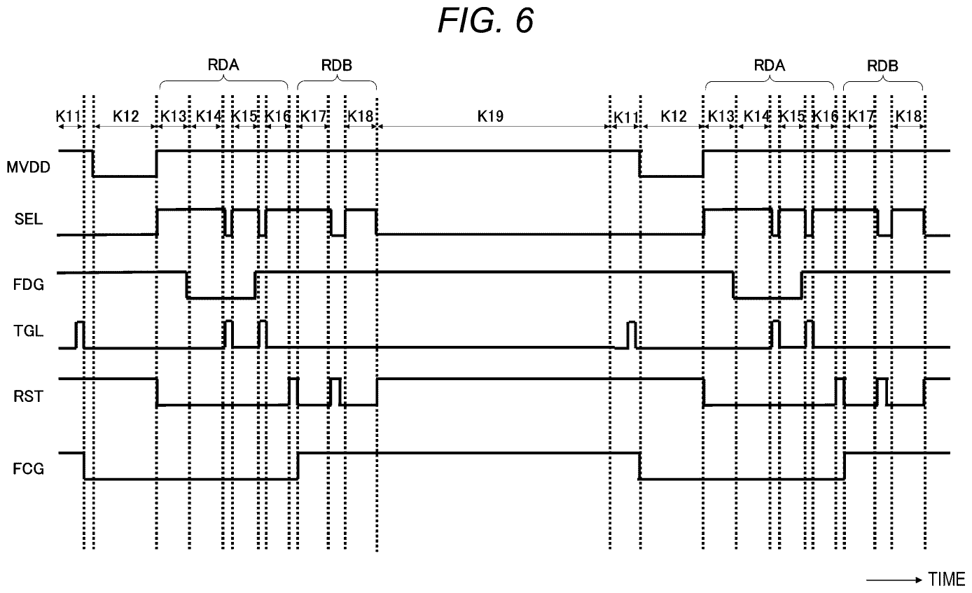

FIG. 6 is a timing chart illustrating an example of waveforms of units in a read operation, a shutter operation, and an accumulation operation of the solid-state imaging device according to the first embodiment.

In FIG. 6, after a pre-accumulation period K19, the processing proceeds to a shutter period K11. In the shutter period K11, the control power supply voltage MVDD is set to the power supply voltage VDD. The selection signal SEL is set to the low level. The switching signal FDG, the reset signal RST, and the pass setting signal FCG are set to the high level. Then, the transfer signal TGL rises, charge of the photodiode 121 and the floating diffusions FD1 to FD3 is discharged, and conversion efficiency in the amplification transistor 124 is reduced. Then, after the transfer signal TGL and the pass setting signal FCG fall, the processing proceeds to an accumulation period K12.

In the accumulation period K12, charge is accumulated in the photodiodes PD1 and PD2 on the basis of incidence of light on the photodiodes PD1 and PD2. Charge overflowing from the photodiode PD2 is accumulated in the capacitor 126. Here, in the accumulation period K12, the control power supply voltage MVDD falls and is set to an intermediate potential. The intermediate potential can be set to a voltage lower than the power supply voltage VDD. Here, in the accumulation period K12, the dark current of the capacitor 126 can be reduced by setting the control power supply voltage MVDD to the intermediate potential.

Next, in a low-efficiency P-phase single read period K13, the reset signal RST falls and the selection signal SEL rises. At this time, the reset transistor 123 is turned off, the selection transistor 125 is turned on, and the potential of the vertical signal line 132 is set on the basis of the source follower operation when the low-efficiency P-phase level of the floating diffusion FD1 is applied to the gate of the amplification transistor 124. Then, the low-efficiency P-phase level is subjected to AD conversion on the basis of the potential of the vertical signal line 132 at that time.

Next, in a high-efficiency P-phase single read period K14, the switching signal FDG falls, and the conversion efficiency in the amplification transistor 124 is increased. Then, the potential of the vertical signal line 132 is set on the basis of the source follower operation when the high-efficiency P-phase level of the floating diffusion FD1 is applied to the gate of the amplification transistor 124. Then, the high-efficiency P-phase level is subjected to AD conversion on the basis of the potential of the vertical signal line 132 at that time.

Thereafter, the selection signal SEL falls and the transfer signal TGL rises. At this time, the selection transistor 125 is turned off, the transfer transistor 122 is turned on, and the charge accumulated in the photodiode PD1 is transferred to the floating diffusion FD1.

Next, in a high-efficiency D-phase single read period K15, the selection signal SEL rises and the transfer signal TGL falls. At this time, the selection transistor 125 is turned on, the transfer transistor 122 is turned off, and the potential of the vertical signal line 132 is set on the basis of the source follower operation when the high-efficiency D-phase level of the floating diffusion FD1 is applied to the gate of the amplification transistor 124. Then, the high-efficiency D-phase level is subjected to AD conversion on the basis of the potential of the vertical signal line 132 at that time.

Then, the switching signal FDG rises, and the conversion efficiency in the amplification transistor 124 is reduced. Furthermore, the selection signal SEL falls and the transfer signal TGL rises. At this time, the selection transistor 125 is turned off, the transfer transistor 122 is turned on, and the charge accumulated in the photodiode PD1 is transferred to the floating diffusion FD1.

Next, in a low-efficiency D-phase single read period K16, the selection signal SEL rises and the transfer signal TGL falls. At this time, the selection transistor 125 is turned on, the transfer transistor 122 is turned off, and the potential of the vertical signal line 132 is set on the basis of the source follower operation when the low-efficiency D-phase level of the floating diffusion FD1 is applied to the gate of the amplification transistor 124. Then, the low-efficiency D-phase level is subjected to AD conversion on the basis of the potential of the vertical signal line 132 at that time.

Thereafter, the reset signal RST rises. At this time, the reset transistor 123 is turned on, and the charge of the floating diffusions FD1 and FD2 is discharged.

In the low-efficiency P-phase single read period K13, the high-efficiency P-phase single read period K14, the high-efficiency D-phase single read period K15, and the low-efficiency D-phase single read period K16, a CDS readout RDA can be performed.

Next, in a D-phase collective read period K17, the reset signal RST falls and the pass setting signal FCG rises. At this time, the reset transistor 123 is turned off, the pass transistor 127 is turned on, and the potential of the vertical signal line 132 is set on the basis of the source follower operation when the D-phase level of the floating diffusion FD3 is applied to the gate of the amplification transistor 124. Then, the D-phase level is subjected to AD conversion on the basis of the potential of the vertical signal line 132 at that time.

Thereafter, the selection signal SEL falls and the reset signal RST rises. At this time, the selection transistor 125 is turned off, the reset transistor 123 is turned on, and the charge of the floating diffusions FD1 to FD3 is discharged.

Next, in a P-phase collective read period K18, the reset signal RST falls and the selection signal SEL rises. At this time, the reset transistor 123 is turned off, the selection transistor 125 is turned on, and the potential of the vertical signal line 132 is set on the basis of the source follower operation when the P-phase level of the floating diffusion FD3 is applied to the gate of the amplification transistor 124. Then, the P-phase level is subjected to AD conversion on the basis of the potential of the vertical signal line 132 at that time. After the P-phase collective read period K18, the processing proceeds to the pre-accumulation period K19.

In the D-phase collective read period K17 and the P-phase collective read period K18, a DDS readout RDB can be performed.

In the pre-accumulation period K19, the voltage applied to the capacitor 126 is controlled so that no voltage is applied to the capacitor 126. At this time, the reset signal RST rises in a state where the pass setting signal FCG has risen. The control power supply voltage MVDD is maintained at the power supply voltage VDD. At this time, the reset transistor 123 and the pass transistor 127 are turned on, and the power supply voltage VDD is applied to both ends of the capacitor 126. As a result, in the pre-accumulation period K19, the voltage applied to the capacitor 126 is controlled so that no voltage is applied to the capacitor 126.

As described above, in the above-described first embodiment, in the pixel 120 provided with the plurality of photodiodes PD1 and PD2 having different sensitivities, the reset transistor 123 and the pass transistor 127 are turned on in the period from the read operation to the shutter operation. As a result, in the pre-accumulation period K19, the voltage applied to the capacitor 126 can be controlled so that no voltage is applied to the capacitor 126. Therefore, it is possible to prevent charge from being accumulated in the capacitor 126 before the start of the accumulation period PK11, and it is possible to suppress an afterimage and deterioration of linearity due to dielectric absorption of the capacitor 126.

### 2. Second Embodiment

In the above-described first embodiment, in the pixel 120 provided with the plurality of photodiodes PD1 and PD2 having different sensitivities, the reset transistor 123 and the pass transistor 127 are turned on in the entire period from the read operation to the shutter operation. In a second embodiment, in a pixel 120 provided with a plurality of photodiodes PD1 and PD2 having different sensitivities, a reset transistor 123 and a pass transistor 127 are turned on from the middle of a period from the read operation to the shutter operation.

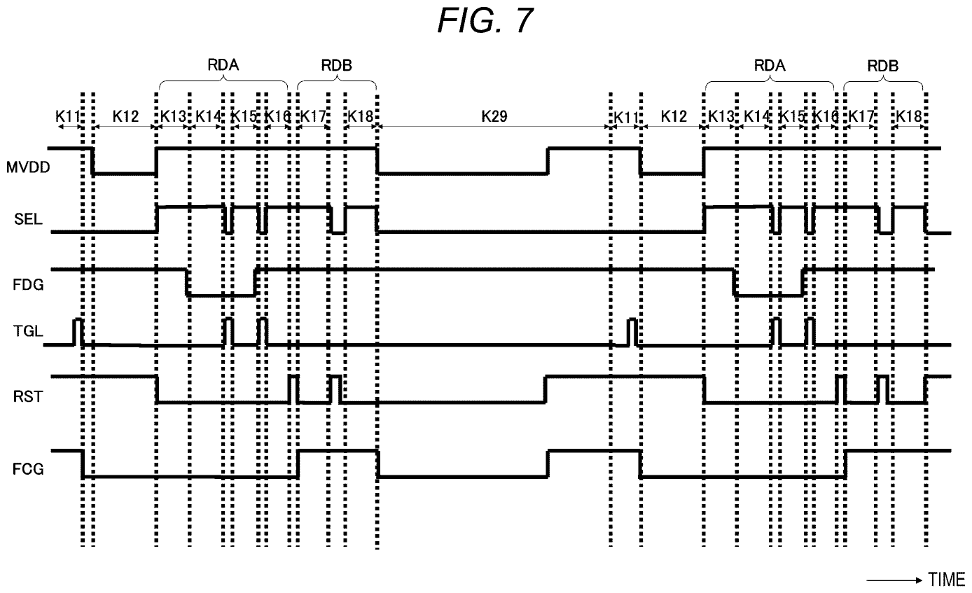

FIG. 7 is a timing chart illustrating an example of waveforms of units in a read operation, a shutter operation, and an accumulation operation of a solid-state imaging device according to the second embodiment.

In FIG. 7, in the solid-state imaging device, a pre-accumulation period K29 is provided instead of the pre-accumulation period K19 of the first embodiment described above. Other operations of the solid-state imaging device of the second embodiment are similar to those of the solid-state imaging device of the first embodiment described above.

In the pre-accumulation period K29, the voltage applied to a capacitor 126 is controlled so that the voltage is not applied to the capacitor 126 from the middle of a period from the read operation to the shutter operation. At this time, when the pre-accumulation period K29 is started, a control power supply voltage MVDD falls and is set to the intermediate potential, and a pass setting signal FCG falls. Here, by setting the control power supply voltage MVDD to the intermediate potential, the voltage applied to the capacitor 126 can be reduced, and the reliability of the capacitor 126 can be improved. Then, for example, in the latter half of the pre-accumulation period K29, the pass setting signal FCG and a reset signal RST rise. At this time, the control power supply voltage MVDD also rises and is set to a power supply voltage VDD. At this time, the reset transistor 123 and the pass transistor 127 are turned on, and the power supply voltage VDD is applied to both ends of the capacitor 126. As a result, in a part of the pre-accumulation period K29, the voltage applied to the capacitor 126 is controlled so that no voltage is applied to the capacitor 126.

As described above, in the above-described second embodiment, in the pixel 120 provided with the plurality of photodiodes PD1 and PD2 having different sensitivities, the reset transistor 123 and the pass transistor 127 are turned on from the middle of the period from the read operation to the shutter operation. As a result, it is possible to prevent a voltage from being applied to the capacitor 126 in a part of the pre-accumulation period K29, and it is possible to suppress an afterimage and deterioration of linearity due to dielectric absorption of the capacitor 126 while suppressing a decrease in reliability of the capacitor 126.

### 3. Third Embodiment

In the above-described first embodiment, in the pixel 120 provided with the plurality of photodiodes PD1 and PD2 having different sensitivities, the reset transistor 123 and the pass transistor 127 are turned on in the entire period from the read operation to the shutter operation. In a third embodiment, in a pixel 120 provided with a plurality of photodiodes PD1 and PD2 having different sensitivities, a reset transistor 123 and a pass transistor 127 are intermittently turned on in a period from the read operation to the shutter operation.

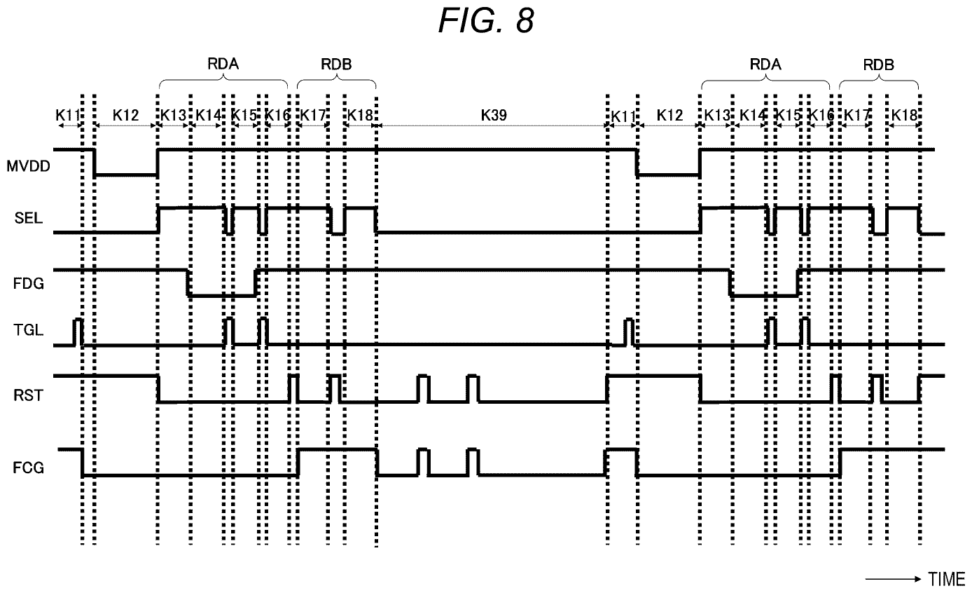

FIG. 8 is a timing chart illustrating an example of waveforms of units in a read operation, a shutter operation, and an accumulation operation of a solid-state imaging device according to the third embodiment.

In FIG. 8, in the solid-state imaging device, a pre-accumulation period K39 is provided instead of the pre-accumulation period K19 of the first embodiment described above. Other operations of the solid-state imaging device of the third embodiment are similar to those of the solid-state imaging device of the first embodiment described above.

In the pre-accumulation period K39, the voltage applied to a capacitor 126 is intermittently controlled so that the voltage is not applied to the capacitor 126 in a period from the read operation to the shutter operation. At this time, when the pre-accumulation period K39 is started, a pass setting signal FCG falls. Thereafter, in the pre-accumulation period K39, the pass setting signal FCG and a reset signal RST rise in a pulse shape. The pass setting signal FCG and the reset signal RST may rise in a pulse shape once or a plurality of times in the pre-accumulation period K39. At this time, a reset transistor 123 and a pass transistor 127 are intermittently turned on, and a power supply voltage VDD is intermittently applied to both ends of the capacitor 126. As a result, in a part of the pre-accumulation period K39, the voltage applied to the capacitor 126 is controlled so that no voltage is applied to the capacitor 126.

As described above, in the above-described third embodiment, in the pixel 120 provided with the plurality of photodiodes PD1 and PD2 having different sensitivities, the reset transistor 123 and the pass transistor 127 are intermittently turned on in the period from the read operation to the shutter operation. As a result, it is possible to prevent a voltage from being intermittently applied to the capacitor 126 in the pre-accumulation period K39, and it is possible to suppress an afterimage and deterioration of linearity due to dielectric absorption of the capacitor 126 while enabling Suppression of a shutter step.

### 4. Fourth Embodiment

In the above-described first embodiment, in the pixel 120 provided with the plurality of photodiodes PD1 and PD2 having different sensitivities, the reset transistor 123 and the pass transistor 127 are turned on in the period from the read operation to the shutter operation. In a fourth embodiment, in a pixel in which a transfer transistor is connected to each of a plurality of photodiodes PD1 and PD2 having different sensitivities, a reset transistor 123 and a pass transistor 127 are turned on in a period from the read operation to the shutter operation.

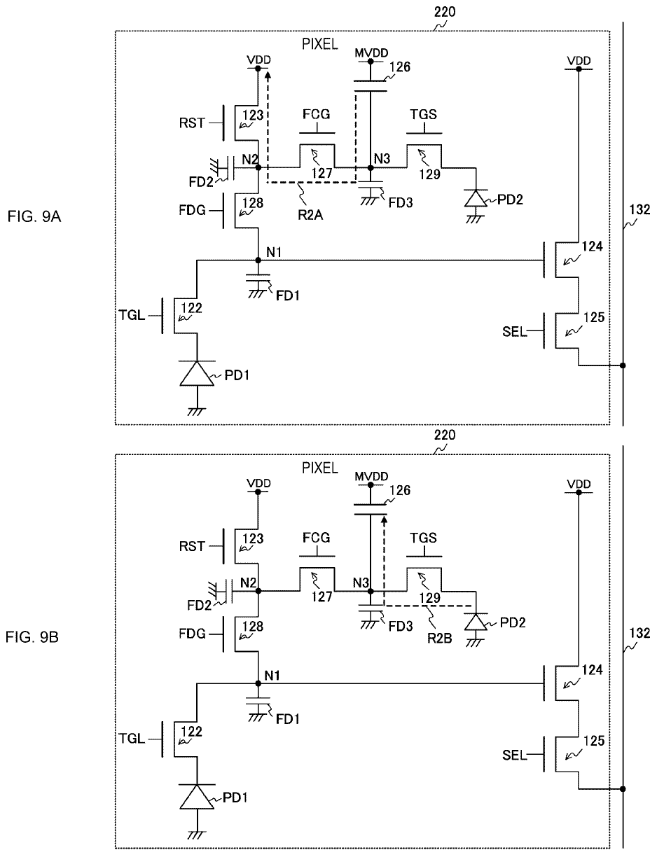

FIG. 9 is a diagram illustrating a circuit configuration example of the pixel provided in a solid-state imaging device according to the fourth embodiment.

In FIG. 9, in a pixel 220, a transfer transistor 129 is added to the pixel 120 of the first embodiment described above. Other configurations of the pixel of the fourth embodiment are similar to those of the pixel 120 of the first embodiment described above.

The transfer transistor 129 is connected between the cathode of the photodiode PD2 and a node N3. A transfer signal TGS is applied to the gate of the transfer transistor 129.

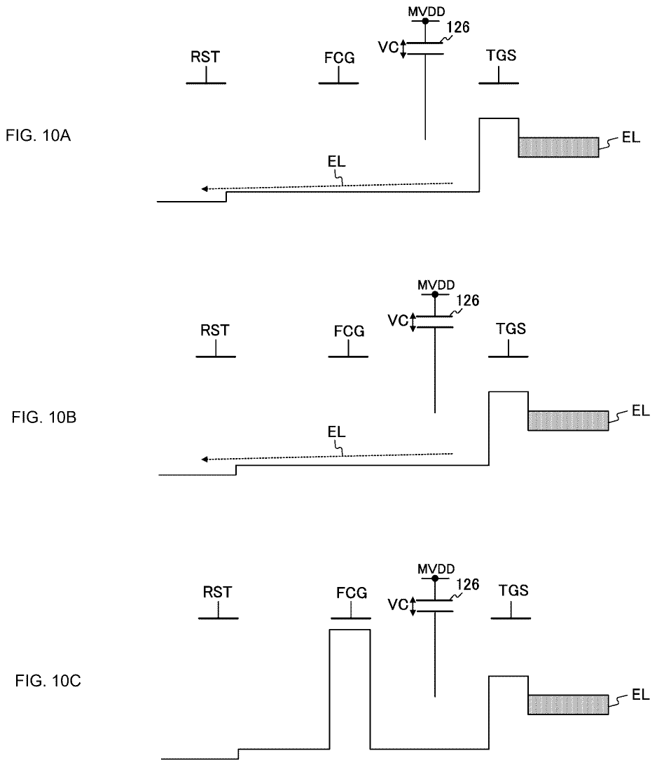

FIG. 10 is a diagram illustrating an example of potentials in a pre-accumulation period and an accumulation period of the solid-state imaging device according to the fourth embodiment. Note that a of FIG. 10 illustrates an example of the potential in the pre-accumulation period. In FIG. 10, b illustrates an example of the potential in the shutter period. In FIG. 10, c illustrates an example of the potential in the accumulation period.

In a and b of FIG. 10, in the pre-accumulation period and the shutter period, a voltage VC applied to the capacitor 126 is controlled so that no voltage is applied to the capacitor 126. Here, a reset signal RST and a pass setting signal FCG are set to the high level in at least a part of a period from the read operation to the shutter operation. At this time, the reset transistor 123 and the pass transistor 127 are turned on, and the potential from the capacitor 126 to a power Supply voltage VDD is set so that charge EL is not accumulated in the capacitor 126. On the other hand, the transfer signal TGS is set to the low level, and the transfer transistor 129 is turned off. Therefore, charge is accumulated in the photodiode PD2 on the basis of incidence of light on the photodiode PD2.

In c of FIG. 10, the capacitor 126 is set to the floating state in the accumulation period. At this time, the pass setting signal FCG is set to the low level, and the pass transistor 127 is turned off. Therefore, charge overflowing from the photodiode PD2 is accumulated in the capacitor 126.

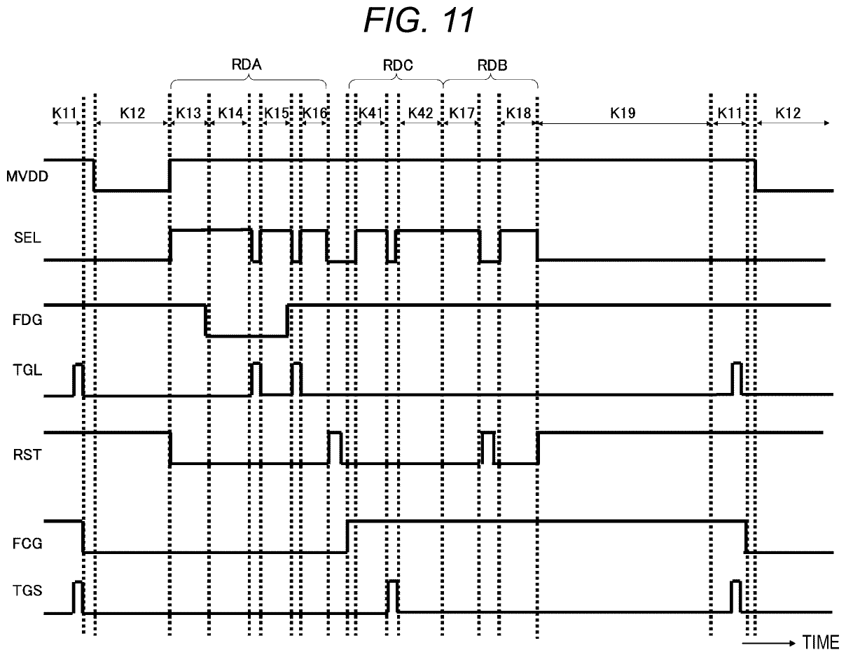

FIG. 11 is a timing chart illustrating an example of waveforms of units in a read operation, a shutter operation, and an accumulation operation of the solid-state imaging device according to the fourth embodiment.

In FIG. 11, in a pixel 220, a P-phase sub-read period K41 and a D-phase sub-read period K42 are added to the read operation of the first embodiment described above. Other operations of the pixel 220 of the fourth embodiment are similar to those of the pixel 120 of the first embodiment described above.

In the read operation of the pixel 220, a selection signal SEL falls at the end of the low-efficiency D-phase single read period K16, and a selection transistor 125 is turned off. Then, after the reset signal RST falls and the pass setting signal FCG rises, the processing proceeds to the P-phase sub-read period K41.

In the P-phase sub-read period K41, the selection signal SEL rises. At this time, the selection transistor 125 is turned on, and the potential of a vertical signal line 132 is set on the basis of the source follower operation when the P-phase sub-level of a floating diffusion FD3 is applied to the gate of an amplification transistor 124. Then, the P-phase sub-level is subjected to AD conversion on the basis of the potential of the vertical signal line 132 at that time.

Thereafter, the selection signal SEL falls and the transfer signal TGS rises. At this time, the selection transistor 125 is turned off, the transfer transistor 129 is turned on, and the charge accumulated in the photodiode PD2 is transferred to the floating diffusion FD3.

Next, in the D-phase sub-read period K42, the selection signal SEL rises and the transfer signal TGS falls. At this time, the selection transistor 125 is turned on, the transfer transistor 129 is turned off, and the potential of the vertical signal line 132 is set on the basis of the source follower operation when the D-phase sub-level of a floating diffusion FD2 is applied to the gate of the amplification transistor 124. Then, the D-phase sub-level is subjected to AD conversion on the basis of the potential of the vertical signal line 132 at that time. After the D-phase sub-read period K42 ends, the processing proceeds to a D-phase collective read period K17.

In the P-phase sub-read period K41 and the D-phase sub-read period K42, a CDS readout RDC can be performed.

As described above, in the fourth embodiment, in the pixel 220 in which the transfer transistors 122 and 129 are connected to each of the plurality of photodiodes PD1 and PD2 having different sensitivities, the reset transistor 123 and the pass transistor 127 are turned on in the period from the read operation to the shutter operation. As a result, it is possible to individually read a signal from the photodiode PD2 while preventing a voltage from being applied to the capacitor 126 in the pre-accumulation period K19. Therefore, it is possible to suppress an afterimage and deterioration of linearity due to dielectric absorption of the capacitor 126 while enabling expansion of the dynamic range.

In the above-described fourth embodiment, the entire period shutter operation in the pre-accumulation period K19 of the above-described first embodiment is taken as an example, but the partial period shutter operation of the above-described second embodiment may be applied, or the intermittent shutter operation of the above-described third embodiment may be applied.

### 5. Fifth Embodiment

In the above-described first embodiment, in the pixel 120 provided with the plurality of photodiodes PD1 and PD2 having different sensitivities, the reset transistor 123 and the pass transistor 127 are turned on in the period from the read operation to the shutter operation. In a fifth embodiment, in a pixel 120 provided with a photodiode PD1, a reset transistor 123 and a pass transistor 127 are turned on in a period from the read operation to the shutter operation.

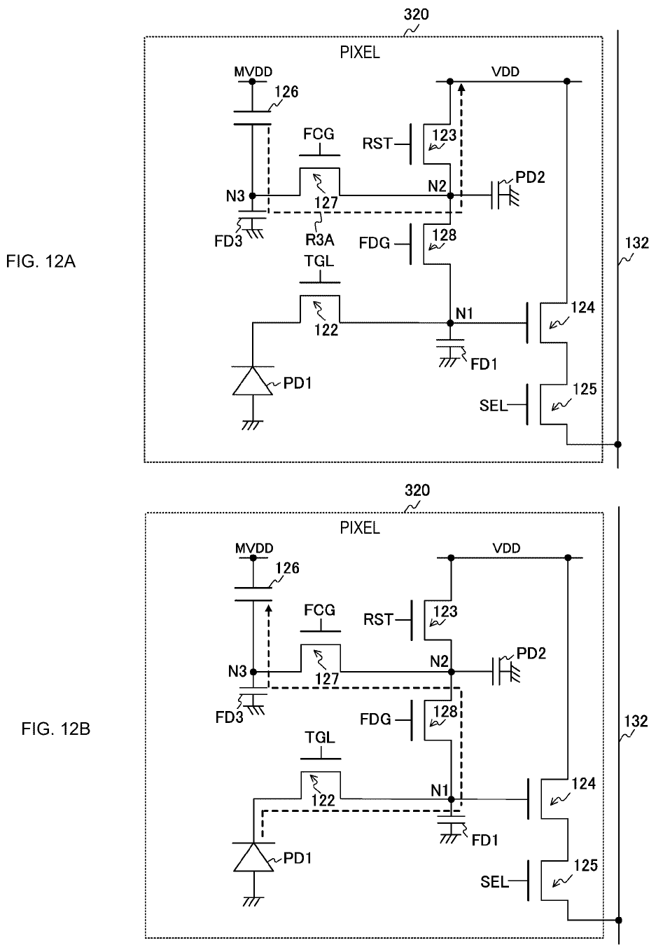

FIG. 12 is a diagram illustrating a circuit configuration example of a pixel provided in a solid-state imaging device according to the fifth embodiment.

In FIG. 12, the photodiode PD2 of the first embodiment described above is removed from a pixel 320. At this time, a capacitor 126 can operate as a lateral overflow integration capacitor that accumulates the charge overflowing from the photodiode PD1. Other configurations of the pixel 320 of the fifth embodiment are similar to those of the pixel 120 of the first embodiment described above.

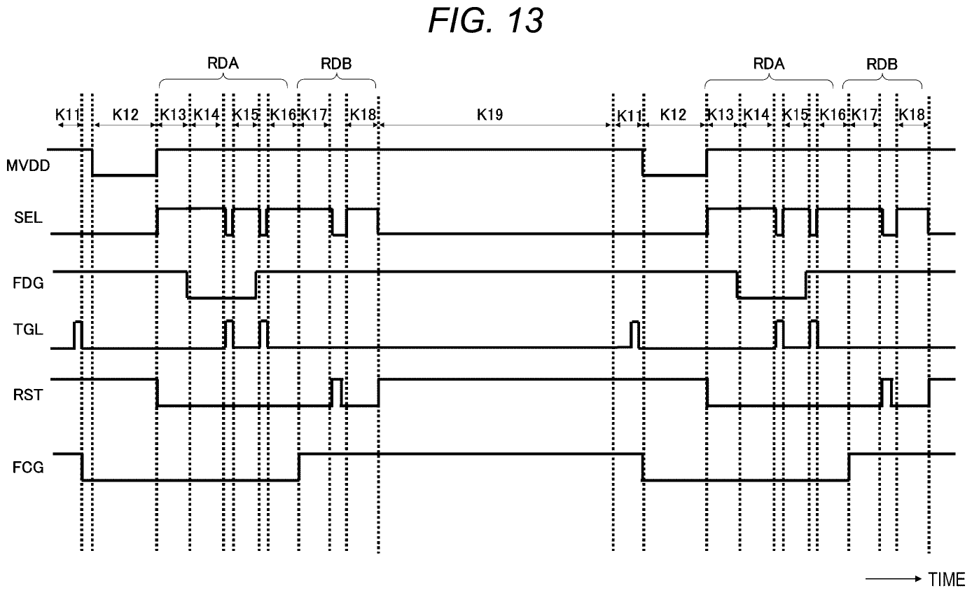

FIG. 13 is a timing chart illustrating an example of waveforms of units in a read operation, a shutter operation, and an accumulation operation of the solid-state imaging device according to the fifth embodiment.

In FIG. 13, in the pixel 320, a reset signal RST is maintained at the low level during the transition from a low-efficiency D-phase single read period K16 to a D-phase collective read period K17. At this time, the processing proceeds to the D-phase collective read period K17 while the charge of floating diffusions FD1 and FD2 is maintained. Then, the potential of a vertical signal line 132 is set on the basis of the source follower operation when the D-phase level of the floating diffusions FD1 to FD3 is applied to the gate of an amplification transistor 124. Then, the D-phase level is subjected to AD conversion on the basis of the potential of the vertical signal line 132 at that time. Other operations of the pixel 320 of the fifth embodiment are similar to those of the pixel 120 of the first embodiment described above.

As described above, in the fifth embodiment, in the pixel 120 provided with the photodiode PD1, the reset transistor 123 and the pass transistor 127 are turned on in a period from the read operation to the shutter operation. As a result, it is possible to operate the capacitor 126 as a lateral overflow integration capacitor that accumulates charge overflowing from the photodiode PD1 while preventing a voltage from being applied to the capacitor 126 in a pre-accumulation period K19. Therefore, it is possible to suppress an afterimage and deterioration of linearity due to dielectric absorption of the capacitor 126 while enabling expansion of the dynamic range.

In the above-described fifth embodiment, the entire period shutter operation in the pre-accumulation period K19 of the above-described first embodiment is taken as an example, but the partial period shutter operation of the above-described second embodiment may be applied, or the intermittent shutter operation of the above-described third embodiment may be applied.

### 6. Sixth Embodiment

In the above-described fifth embodiment, the capacitor 126 turns on the reset transistor 123 and the pass transistor 127 in the period from the read operation to the shutter operation in the pixel 320 in which the capacitor 126 is operated as a lateral overflow integration capacitor that accumulates charge overflowed from the photodiode PD1. In a sixth embodiment, in a pixel in which an overflow control transistor is provided between a photodiode PD1 and a lateral overflow integration capacitor, a reset transistor 123 and a pass transistor 127 are turned on in a period from the read operation to the shutter operation.

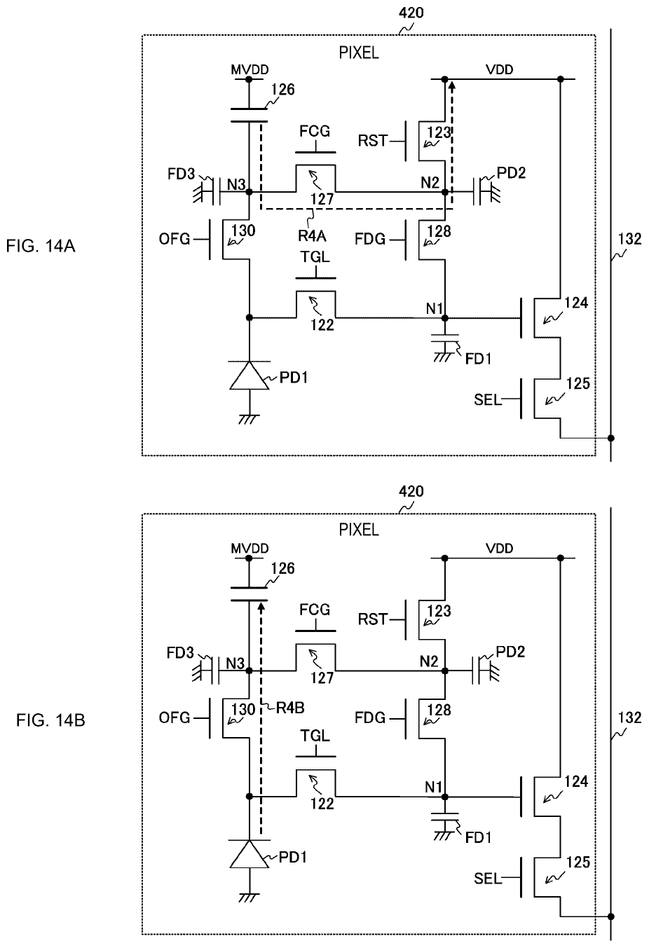

FIG. 14 is a diagram illustrating a circuit configuration example of a pixel provided in a solid-state imaging device according to the sixth embodiment.

In FIG. 14, in a pixel 420, an overflow control transistor 130 is added to the pixel 320 of the fifth embodiment described above. Other configurations of the pixel 420 of the sixth embodiment are similar to those of the pixel 120 of the first embodiment described above.

The overflow control transistor 130 is connected between the photodiode PD1 and a capacitor 126. An overflow control voltage OFG is applied to the gate of the overflow control transistor 130. The overflow control voltage OFG can control the overflow of charge from the photodiode PD1 to the capacitor 126. The overflow control voltage OFG may be a fixed voltage. The read operation of the pixel 420 is similar to the read operation of the pixel 320 of the fifth embodiment described above.

As described above, in the above-described sixth embodiment, in the pixel 420 in which the overflow control transistor 130 is provided between the photodiode PD1 and the capacitor 126, the reset transistor 123 and the pass transistor 127 are turned on in the period from the read operation to the shutter operation. As a result, it is possible to control the overflow of the charge from the photodiode PD1 while preventing a voltage from being applied to the capacitor 126 in the pre-accumulation period K19. Therefore, it is possible to suppress an afterimage and deterioration of linearity due to dielectric absorption of the capacitor 126 while enabling expansion of the dynamic range.

In the above-described sixth embodiment, the entire period shutter operation in the pre-accumulation period K19 of the above-described first embodiment is taken as an example, but the partial period shutter operation of the above-described second embodiment may be applied, or the intermittent shutter operation of the above-described third embodiment may be applied.

### 7. Seventh Embodiment

In the above-described first embodiment, the capacitor 126 is reset in the pre-accumulation period. In a seventh embodiment, a capacitor 126 is reset during the accumulation period.

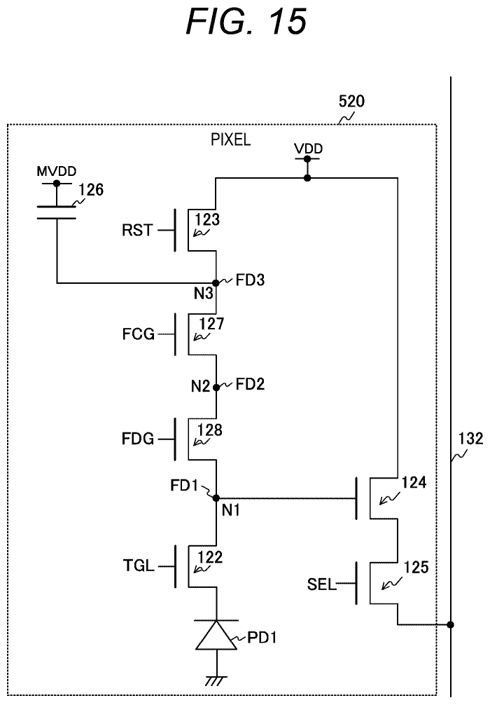

FIG. 15 is a diagram illustrating a circuit configuration example of a pixel provided in a solid-state imaging device according to the seventh embodiment.

In FIG. 15, in a pixel 520, the photodiode PD2 is removed from the pixel 120 of the first embodiment described above. Furthermore, a reset transistor 123 is connected between a power supply voltage VDD and a node N3. Other configurations of the pixel 520 of the seventh embodiment are similar to those of the pixel 120 of the first embodiment described above.

By connecting the reset transistor 123 between the power supply voltage VDD and the node N3, the capacitor 126 can be reset without turning on a pass transistor 127. Here, by turning off the pass transistor 127, the capacitor 126 can be reset without discharging the charge accumulated in a floating diffusion FD2. When the capacitor 126 is reset, a switching transistor 128 is turned on, and the capacitance of the preceding stage of the pass transistor 127 can be increased. Therefore, it is possible to reset the capacitor 126 during the accumulation period while suppressing the decrease in the dynamic range. Note that the reset transistor 123 is an example of a third transistor in an embodiment of the present disclosure.

Here, a control circuit 116 can control driving of the switching transistor 128, the pass transistor 127, and the reset transistor 123. At this time, the control circuit 116 can turn on the reset transistor 123 during at least a part of the accumulation period in a photodiode PD1. Furthermore, when turning on the reset transistor 123 in at least a part of the accumulation period in the photodiode PD1, the control circuit 116 can turn on the switching transistor 128 and turn off the pass transistor 127.

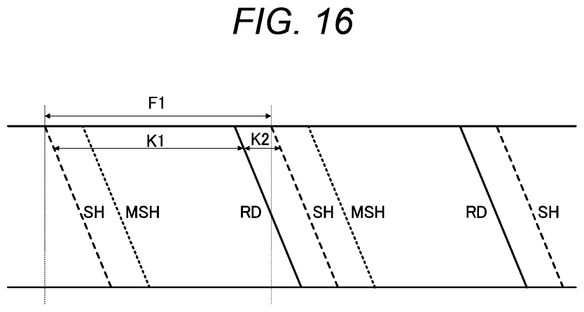

FIG. 16 is a timing chart illustrating an example of a relationship between a read operation and a shutter operation of the solid-state imaging device according to the seventh embodiment.

In FIG. 16, in the solid-state imaging device, a shutter operation SH and a sub-shutter operation MSH are repeated for each frame F1. Each frame F1 is provided with an accumulation period K1 and a vertical blanking period K2. At this time, the solid-state imaging device performs the sub-shutter operation MSH during the accumulation period K1 in each frame F1.

Here, the accumulation period K1 is set in a period from the shutter operation SH to a read operation RD of each frame F1. Furthermore, the vertical blanking period K2 is set to a period from the read operation RD to the shutter operation SH of the next frame F1.

In the sub-shutter operation MSH, the solid-state imaging device turns on the switching transistor 128, turns off the pass transistor 127, and turns on the reset transistor 123. At this time, the solid-state imaging device can reset the capacitor 126 without discharging the charge accumulated in the floating diffusion FD2.

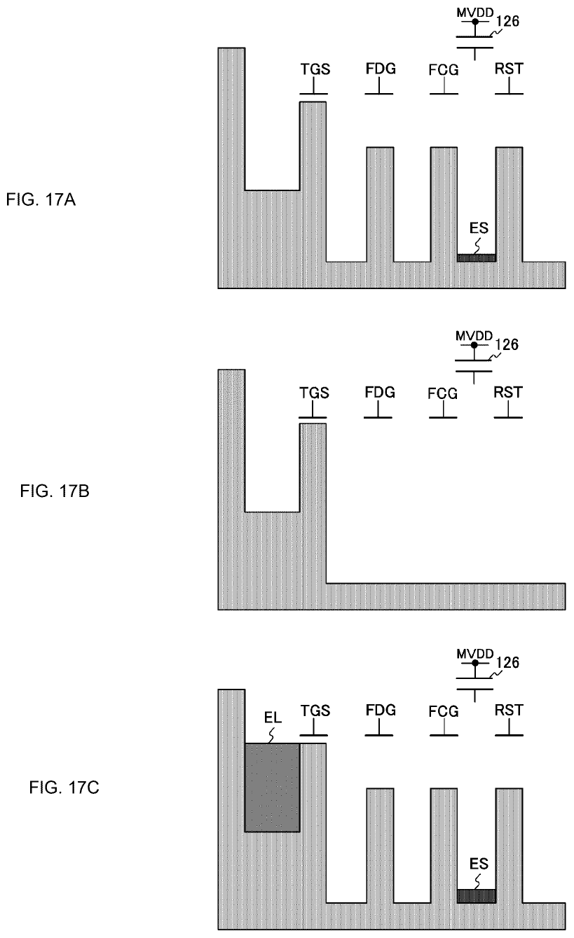

FIGS. 17 to 19 are diagrams illustrating a first example of potentials of the vertical blanking period and the accumulation period of the solid-state imaging device according to the seventh embodiment. Note that in FIGS. 17 to 19, an example is illustrated in which the signal charge accumulated before the sub-shutter operation MSH is less than a maximum number of electrons FDQ received at the preceding stage of the pass transistor 127.

In a of FIG. 17, in the vertical blanking period K2, the switching transistor 128, the pass transistor 127, and the reset transistor 123 are turned off. At this time, a return voltage ES due to dielectric absorption of the capacitor 126 is generated at the node N3.

Next, as illustrated in b of FIG. 17, in the shutter operation SH, the switching transistor 128, the pass transistor 127, and the reset transistor 123 are turned on. At this time, at the node N3, the return voltage ES due to dielectric absorption of the capacitor 126 is reset.

Next, as illustrated in c of FIG. 17, in the accumulation period K1, the switching transistor 128, the pass transistor 127, and the reset transistor 123 are turned off. At this time, charge EL is accumulated in the photodiode PD1 on the basis of incidence of light on the photodiode PD1. At the node N3, the return voltage ES due to dielectric absorption of the capacitor 126 is generated.

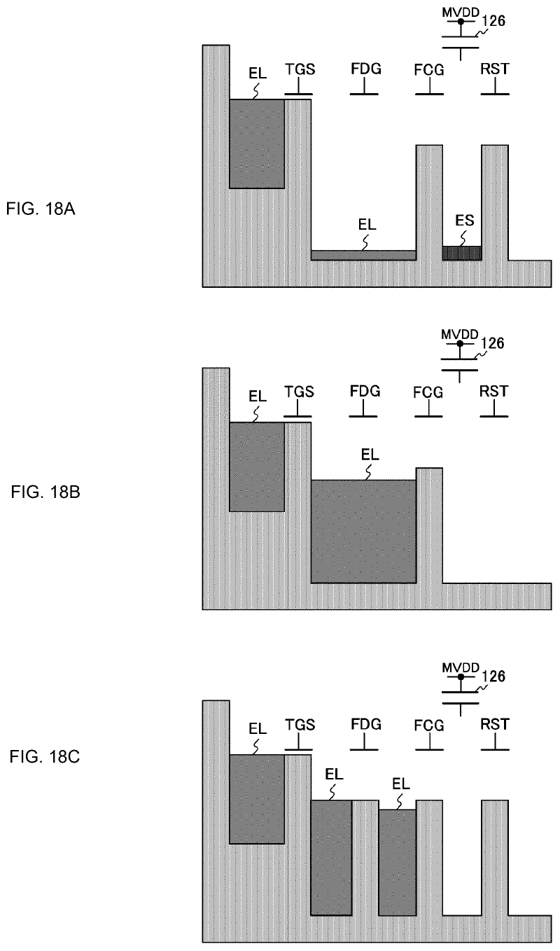

Next, as illustrated in a of FIG. 18, the switching transistor 128 is turned on. At this time, the nodes N1 and N2 are coupled, and the capacity between nodes N1 and N2 is increased. The charge EL overflowing from the photodiode PD1 can be accumulated between the nodes N1 and N2, and the dynamic range can be expanded. At this time, the number of electrons FDQ received at the preceding stage of the pass transistor 127 increases. This number of electrons FDQ is proportional to the potential range and inversely proportional to the conversion efficiency. In terms of conversion efficiency, the potential range is expanded on the basis of the boost caused by turning on the switching transistor 128, and the number of electrons FDQ is increased due to a decrease in conversion efficiency caused by the gate capacitance. By temporarily holding the number of electrons received by the floating diffusion FD3 in the floating diffusions FD1 and FD2, the capacitor 126 can be reset during the accumulation period without reducing the dynamic range. Here, under a condition that the number of electrons FDQ falls within a dynamic range defined by the circuit side such as an AD converter, the sub-shutter operation MSH may be performed at an arbitrary timing in the accumulation period K1.

Next, as illustrated in b of FIG. 18, in the sub-shutter operation MSH, the reset transistor 123 is turned on while the pass transistor 127 is turned off. At this time, the return voltage ES due to the dielectric absorption of the capacitor 126 is reset at the node N3 while the charge EL overflowing from the photodiode PD1 is accumulated between the nodes N1 and N2.

Next, as illustrated in c of FIG. 18, the switching transistor 128 and the reset transistor 123 are turned off. At this time, the coupling between the nodes N1 and N2 is eliminated, and the charge EL overflowing from the photodiode PD1 is distributed to the nodes N1 and N2.

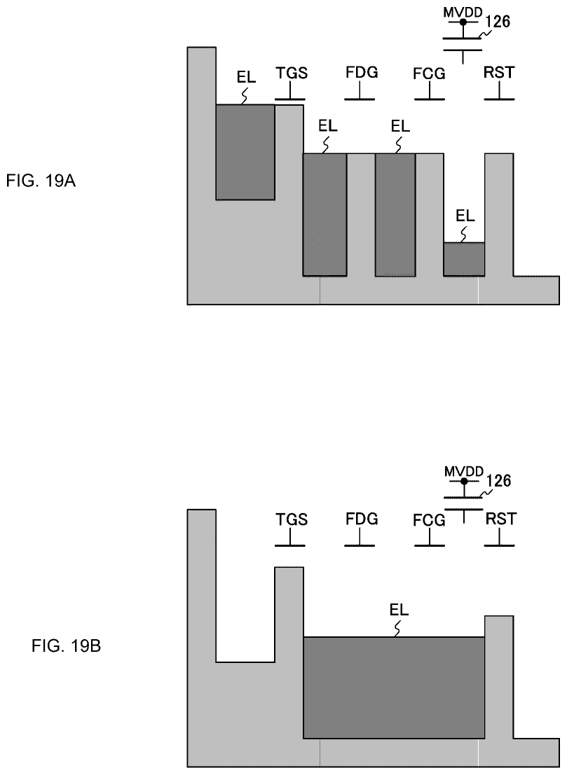

Next, as illustrated in a of FIG. 19, when the accumulation period K1 progresses, the charge EL overflowing from the photodiode PD1 also overflows from the nodes N1 and N2 and is also accumulated in the node N3.

Next, as illustrated in b of FIG. 19, in the D-phase readout, the switching transistor 128 and the pass transistor 127 are turned on, and the nodes N1 to N3 are coupled.

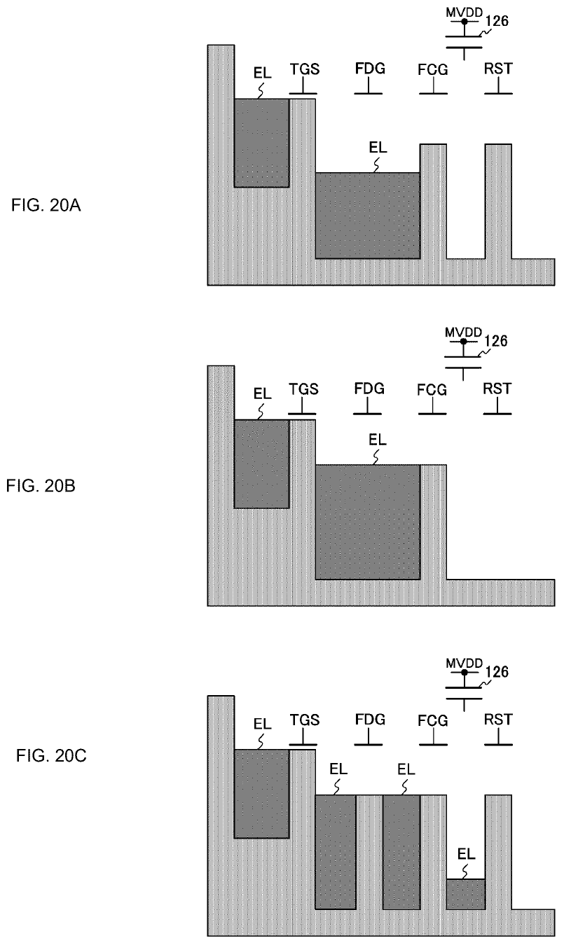

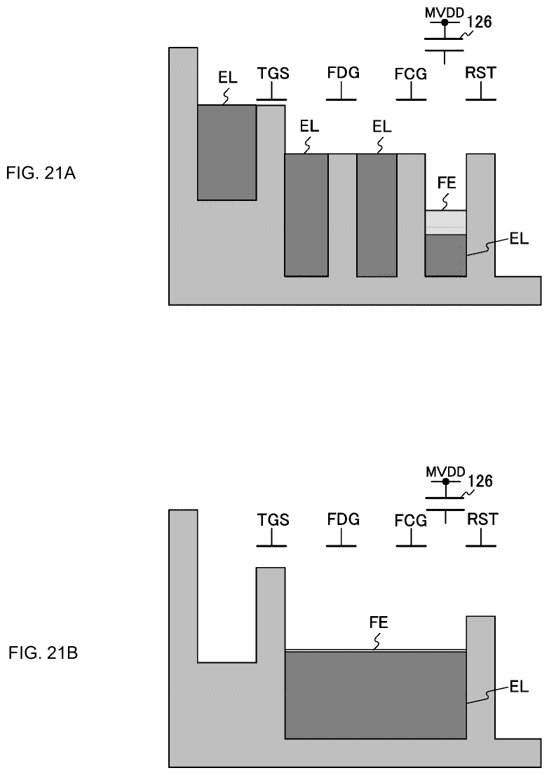

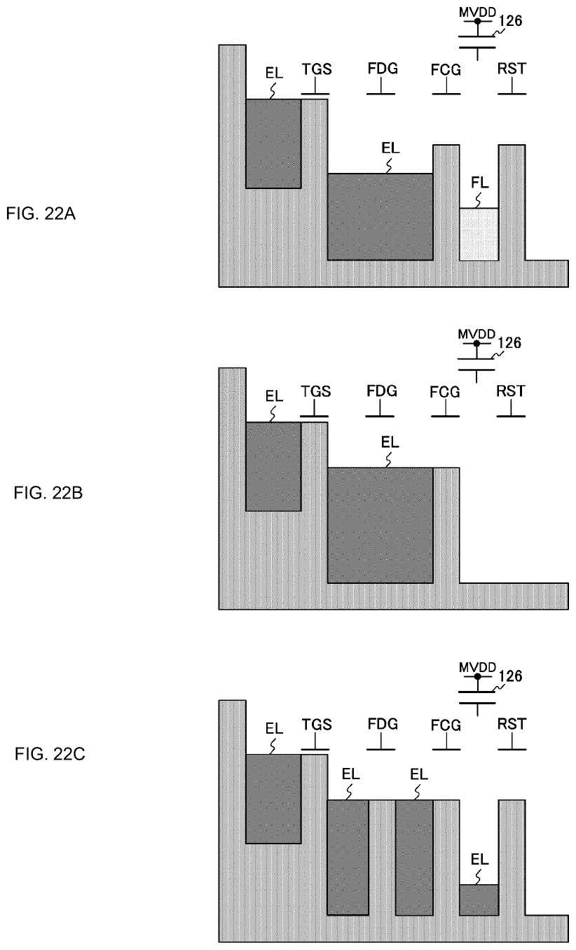

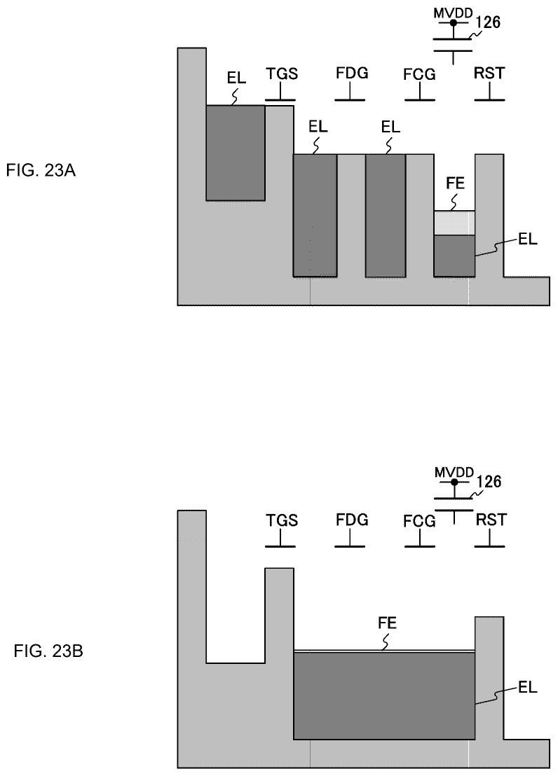

FIGS. 20 and 21 are diagrams illustrating a second example of the potentials of the vertical blanking period and the accumulation period of the solid-state imaging device according to the seventh embodiment. Note that FIGS. 20 and 21 illustrate an example in which the dynamic range corresponding to the maximum number of electrons FDQ received at the preceding stage of the pass transistor 127 corresponds to the dynamic range defined by the circuit side such as the AD converter. In this example, the sub-shutter operation MSH can be executed at an arbitrary timing. FIGS. 22 and 23 illustrate an example in which the sub-shutter operation MSH is executed before the charge generated in the photodiode PD1 flows into the node N3.

In a of FIG. 20, the switching transistor 128 is turned on. At this time, the nodes N1 and N2 are coupled, and the capacity between nodes N1 and N2 is increased. The charge EL overflowing from the photodiode PD1 is accumulated between the nodes N1 and N2.

Next, as illustrated in b of FIG. 20, when the accumulation period K1 progresses, the charge EL accumulated between the nodes N1 and N2 before the sub-shutter operation MSH reaches the level corresponding to the dynamic range. At this time, when the sub-shutter operation MSH is performed, the return voltage due to the dielectric absorption of the capacitor 126 is reset at the node N3 while the charge EL overflowing from the photodiode PD1 is accumulated between the nodes N1 and N2.

Next, as illustrated in c of FIG. 20, the switching transistor 128 and the reset transistor 123 are turned off. At this time, the coupling between the nodes N1 and N2 is eliminated, and the charge EL accumulated between the nodes N1 and N2 overflows to the node N3.

Next, as illustrated in a of FIG. 21, when the accumulation period K1 progresses, charge FE overflowing from the photodiode PD1 beyond the dynamic range is accumulated in the node N3 via the nodes N1 and N2.

Next, as illustrated in b of FIG. 21, in the D-phase readout, the switching transistor 128 and the pass transistor 127 are turned on, and the nodes N1 to N3 are coupled. At this time, since the charge FE accumulated in the node N3 beyond the dynamic range exceeds the detection range on the circuit side, the charge FE reaches the full code in the D-phase readout, and does not affect the output. Therefore, an afterimage can be suppressed without reducing the dynamic range.

FIGS. 22 and 23 are diagrams illustrating a third example of the potentials of the vertical blanking period and the accumulation period of the solid-state imaging device according to the seventh embodiment. Note that FIGS. 22 and 23 illustrate an example in which the dynamic range corresponding to the maximum number of electrons FDQ received at the preceding stage of the pass transistor 127 exceeds the dynamic range defined by the circuit side such as the AD converter. In this example, the sub-shutter operation MSH can be executed at an arbitrary timing. FIGS. 22 and 23 illustrate an example in which the sub-shutter operation MSH is executed after the charge generated in the photodiode PD1 flows into the node N3.

In a of FIG. 22, the switching transistor 128 is turned on. At this time, the nodes N1 and N2 are coupled, and the capacity between nodes N1 and N2 is increased. Then, charge FL overflowing from the photodiode PD1 beyond the dynamic range is accumulated in the node N3 via the nodes N1 and N2.

Next, as illustrated in b of FIG. 22, in the sub-shutter operation MSH, the reset transistor 123 is turned on while the pass transistor 127 is turned off. At this time, while the charge EL overflowing from the photodiode PD1 is accumulated between the nodes N1 and N2, the return voltage due to the dielectric absorption of the capacitor 126 is reset at the node N3. In addition, the charge FL accumulated in the node N3 beyond the dynamic range is discharged.

Next, as illustrated in c of FIG. 22, the switching transistor 128 and the reset transistor 123 are turned off. At this time, the coupling between the nodes N1 and N2 is eliminated, and the charge EL accumulated between the nodes N1 and N2 overflows to the node N3.

Next, as illustrated in a of FIG. 23, when the accumulation period K1 progresses, charge FE overflowing from the photodiode PD1 beyond the dynamic range is accumulated in the node N3 via the nodes N1 and N2.

Next, as illustrated in b of FIG. 23, in the D-phase readout, the switching transistor 128 and the pass transistor 127 are turned on, and the nodes N1 to N3 are coupled. At this time, since the charge FE accumulated in the node N3 beyond the dynamic range exceeds the detection range on the circuit side, the charge FE reaches the full code in the D-phase readout, and does not affect the output. Therefore, an afterimage can be suppressed without reducing the dynamic range.

As described above, in the above-described seventh embodiment, the switching transistor 128 is turned on, the pass transistor 127 is turned off, and the reset transistor 123 is turned on during the accumulation period. As a result, the capacitor 126 can be reset without discharging the charge accumulated in the floating diffusion FD2. Therefore, it is possible to suppress an afterimage and deterioration of linearity due to dielectric absorption of the capacitor 126 while suppressing a decrease in the dynamic range.

### 8. Eighth Embodiment

In the seventh embodiment described above, the capacitor 126 is reset during the accumulation period without discharging the charge accumulated in the floating diffusion FD2. In an eighth embodiment, the gate voltage of a pass transistor 127 is made variable during the accumulation period.

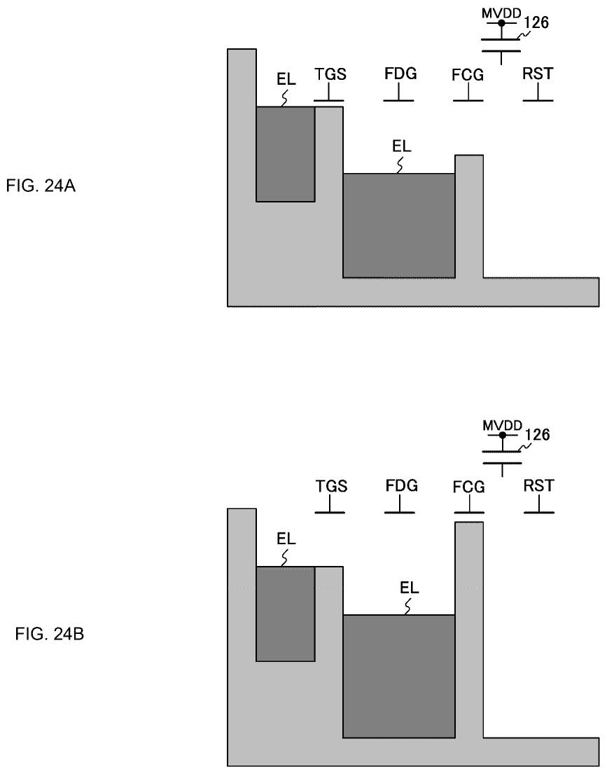

FIG. 24 is a diagram illustrating an example of potentials in the accumulation period of a solid-state imaging device according to the eighth embodiment.

In a of FIG. 24, when the pass transistor 127 is turned off, a potential barrier that accumulates charge EL is formed between nodes N1 and N2. At this time, the number of electrons FDQ received at the preceding stage of the pass transistor 127 depends on the height of the potential barrier.

Therefore, in order to increase the number of electrons FDQ received at the preceding stage of the pass transistor 127, the negative voltage of the gate of the pass transistor 127 may be made variable. For example, as illustrated in b of FIG. 24, by increasing the negative voltage of the gate of the pass transistor 127, the potential barrier for accumulating the charge EL between the nodes N1 and N2 can be increased, and the number of electrons FDQ received at the preceding stage of the pass transistor 127 can be increased.

As described above, in the above-described eighth embodiment, the gate voltage of the pass transistor 127 is made variable during the accumulation period. As a result, the capacitor 126 can be reset in the accumulation period while increasing the capacitance of the floating diffusion capable of accumulation in the accumulation period.

### 9. Ninth Embodiment

In the seventh embodiment described above, the capacitor 126 is reset during the accumulation period without discharging the charge accumulated in the floating diffusion FD2. In a ninth embodiment, a capacitor that is not affected by dielectric absorption is added.

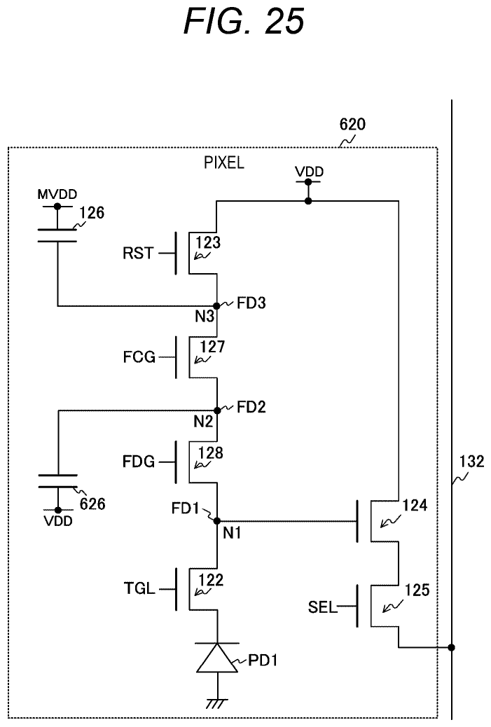

FIG. 25 is a diagram illustrating a circuit configuration example of a pixel provided in a solid-state imaging device according to the ninth embodiment.

In FIG. 25, in a pixel 620, a capacitor 626 is added to the pixel 520 of the above-described seventh embodiment. Other configurations of the pixel 620 of the ninth embodiment are similar to those of the pixel 520 of the seventh embodiment described above.

The capacitor 626 is connected between a node N2 and a power supply voltage VDD. The capacitor 626 may be configured so as not to be affected by dielectric absorption, or may control reading from the capacitor 626 so as not to be affected by dielectric absorption. For example, the capacitor 626 may be made of a material that does not cause polarization in insulation between electrodes, or CDS may be performed for reading from the capacitor 626.

As described above, in the above-described ninth embodiment, the capacitor 626 not affected by dielectric absorption is connected to the node N2. As a result, it is possible to increase the number of electrons FDQ received at a preceding stage of a pass transistor 127 at the time of resetting a capacitor 126 during the accumulation period, and it is possible to expand the dynamic range while suppressing the occurrence of an afterimage.

### 10. 10th Embodiment

In the seventh embodiment described above, the capacitor 126 is reset during the accumulation period without discharging the charge accumulated in the floating diffusion FD2. In a 10th embodiment, an embedded gate is provided in a switching transistor.

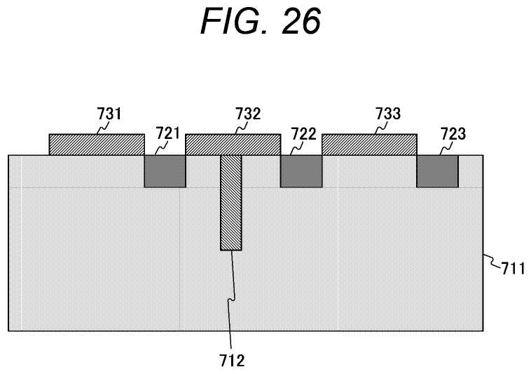

FIG. 26 is a cross-sectional view illustrating a circuit configuration example of a pixel provided in a solid-state imaging device according to the 10th embodiment.

In FIG. 26, impurity diffusion layers 721 to 723 are formed separately from each other on a semiconductor substrate 711. As the material of the semiconductor substrate 711, Si, InP, InGaP, InAlP, InGaAs, InAlAs, or a compound semiconductor having a chalcopyrite structure can be used. The impurity diffusion layers 721 to 723 can be used as floating diffusions FD1 to FD3.

On the semiconductor substrate 711, a gate electrode 731 is formed so as to have an end portion on the impurity diffusion layer 721. Moreover, on the semiconductor substrate 711, a gate electrode 732 is formed so as to extend between the impurity diffusion layers 721 and 722. Furthermore, on the semiconductor substrate 711, a gate electrode 733 is formed so as to extend between the impurity diffusion layers 722 and 723. In order to insulate each of the gate electrodes 731 to 733 from the semiconductor substrate 711, a gate insulating film is formed between each of the gate electrodes 731 to 733 and the semiconductor substrate 711. The gate electrodes 731 to 733 can be used for a transfer transistor 122, a switching transistor 128, and a pass transistor 127, respectively.

Furthermore, an embedded gate 712 is embedded in the semiconductor substrate 711. The embedded gate 712 is connected to the gate electrode 732. In order to insulate the embedded gate 712 from the semiconductor substrate 711, a gate insulating film is formed between the embedded gate 712 and the semiconductor substrate 711. Here, by providing the embedded gate 712 connected to the gate electrode 732, the gate capacitance of the switching transistor 128 can be increased.

As described above, in the above-described 10th embodiment, the embedded gate 712 is provided in the switching transistor 128. As a result, it is possible to increase the number of electrons FDQ received at a preceding stage of a pass transistor 127 at the time of resetting a capacitor 126 during the accumulation period, and it is possible to expand the dynamic range while suppressing the occurrence of an afterimage.

### 11. 11th Embodiment

In the above-described first embodiment, in the pixel 120 in which the photodiodes PD1 and PD2 having different sensitivities are provided, the reset transistor 123 and the pass transistor 127 that are turned on in the period from the read operation to the shutter operation are provided. In this 11th embodiment, a semiconductor chip provided with a pixel array unit in which pixels are arranged in a matrix is laminated.

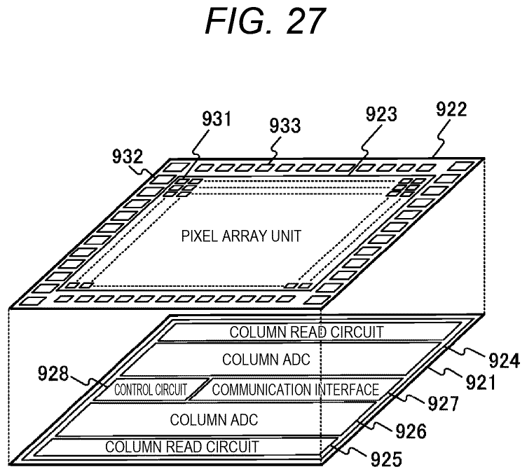

FIG. 27 is a perspective view illustrating a lamination example of a pixel array unit according to the 11th embodiment.

In FIG. 27, a solid-state imaging device includes semiconductor chips 921 and 922. The semiconductor chip 922 is laminated on the semiconductor chip 921.

A pixel array unit 923 is arranged on the semiconductor chip 922. The pixel array unit 923 includes pixels 931 arranged in a matrix in a row direction and a column direction. The pixel 931 may be any pixel of the first to sixth embodiments described above. Pad electrodes 932 and via electrodes 933 are formed around the pixel array unit 923. The via electrode 933 penetrates the semiconductor chip 922 and can electrically connect the semiconductor chips 921 and 922 to each other.

A peripheral circuit 924 is formed on the semiconductor chip 921. In the peripheral circuit 924, a column read circuit 925, a column ADC 926, a communication interface 927, and a control circuit 928 are formed. The column read circuit 925 and the column ADC 926 may be formed in such a way as to correspond to positions on both sides of the pixel array unit 923 in the column direction.

The control circuit 928 can control the voltage applied to the capacitor of each pixel 931 so that a voltage is not applied to the capacitor in a pre-accumulation period before an accumulation period in which charge is accumulated in the photodiode of each pixel 931. The pre-accumulation period can be set to at least a part of a period from a read operation of reading the pixel voltage from the pixel 931 to a shutter operation.

The semiconductor chips 921 and 922 may be directly bonded. For the direct bonding between the semiconductor chips 921 and 922, hybrid bonding can be used. At this time, the semiconductor chips 921 and 922 may be electrically connected to each other on the basis of Cu-Cu connection. The material of semiconductor substrates used for the semiconductor chips 921 and 922 may be Si, InGaAs, or InP.

As described above, in the above-described 11th embodiment, the semiconductor chip 922 on which the pixel array unit 923 is formed is laminated on the semiconductor chip 921 on which the peripheral circuit 924 is formed. This makes it possible to increase sensitivity of the solid-state imaging device while Suppressing an increase in the mounting area of the semiconductor chip on which the solid-state imaging device is formed.

### 12. Example of Application to Mobile Body

The technology according to the present disclosure (present technology) can be applied to various products. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

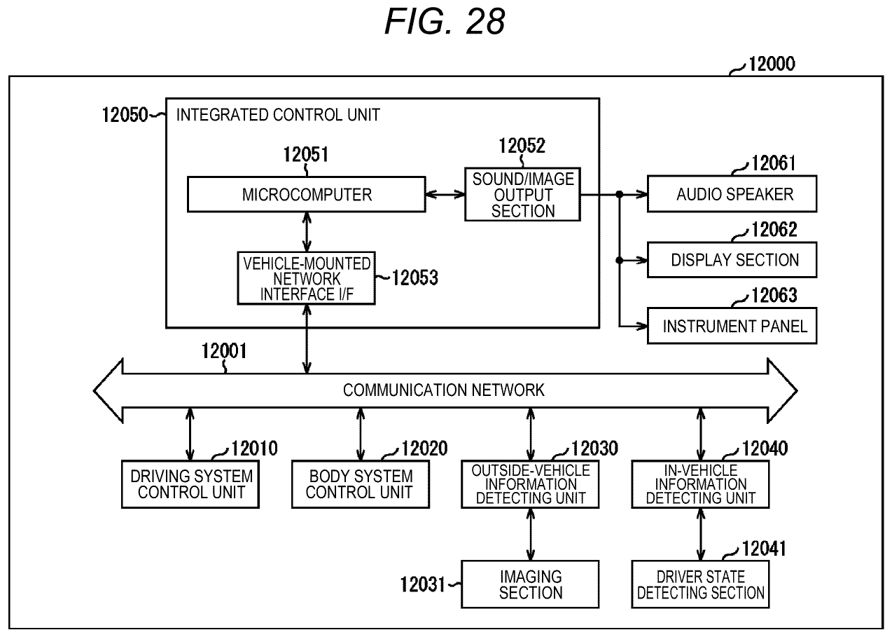

FIG. 28 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 28, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. Furthermore, the light received by the imaging section 12031 may be visible light, or may be invisible light such as infrared rays.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 28, as the output device, an audio speaker 12061, a display section 12062, and an instrument panel 12063 are illustrated. The display section 12062 may, for example, include at least one of an on-board display and a head-up display.

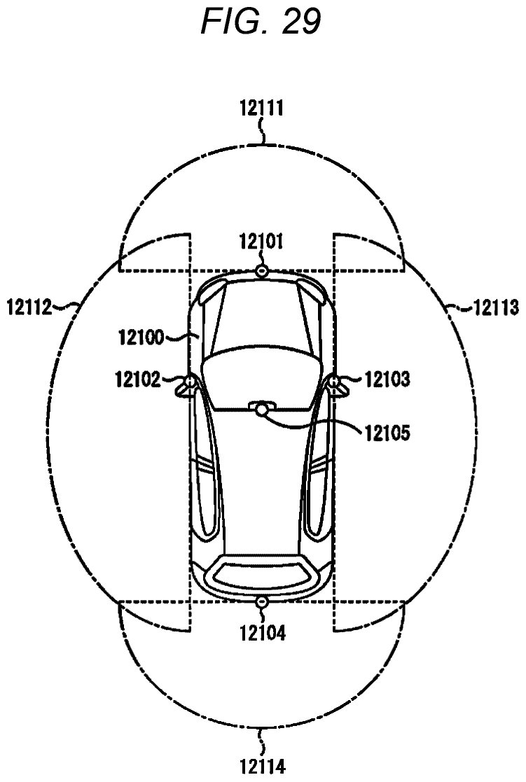

FIG. 29 is a diagram illustrating an example of an installation position of the imaging section 12031.

In FIG. 29, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 29 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the configurations described above. Specifically, for example, the above-described imaging device can be applied to the imaging section 12031. By applying the technology according to the present disclosure to the vehicle control system 12000, it is possible to suppress an afterimage and deterioration of linearity at the time of imaging while enabling expansion of the dynamic range.

Note that the embodiments described above indicate examples for embodying the present technology, and the matters in the embodiments and the matters specifying the invention in the claims have correspondence relationships. Similarly, the matters specifying the invention in the claims and matters with the same names in the embodiments of the present technology have correspondence relationships. The present technology, however, is not limited to the embodiments, and can be implemented by making various modifications to the embodiments without departing from the scope of the present technology. Furthermore, effects described in the present specification are merely examples and not limited, and other effects may be provided.

Note that the present technology may also have the following configurations.

(1) An imaging device including:

a photoelectric conversion unit;

a capacitor having one end connected to the photoelectric conversion unit;

a first transistor having one end connected to the capacitor and the other end connected to a first node;

a second transistor having one end connected to the first node and the other end connected to a power supply; and

a control unit that controls driving of the first transistor and the second transistor, in which

the control unit turns on the first transistor and the second transistor in at least a part of a period from a read operation of reading a pixel voltage of the first node to a shutter operation of the photoelectric conversion unit.

(2) The imaging device according to (1), in which the control unit controls a voltage applied to the capacitor so that a voltage is not applied to the capacitor before an accumulation period in which charge is accumulated in the photoelectric conversion unit.

(3) The imaging device according to (1) or (2), in which the capacitor is a high dielectric capacitor.

(4) The imaging device according to any one of (1) to (3), in which the capacitor accumulates charge overflowing from the photoelectric conversion unit.

(5) The imaging device according to any one of (1) to (4), in which the control unit reads a signal from the capacitor on the basis of double data sampling (DDS) driving.

(6) The imaging device according to any one of (1) to (5), in which the other end of the capacitor is connected to a control power supply, and in an accumulation period, a potential of the control power supply is set to an intermediate potential lower than a potential of the power supply.

(7) The imaging device according to any one of (1) to (6), in which:

the photoelectric conversion unit includes

a first photoelectric conversion unit, and

a second photoelectric conversion unit having lower sensitivity than the first photoelectric conversion unit; and

the capacitor accumulates charge overflowing from the second photoelectric conversion unit.

(8) The imaging device according to any one of (1) to (7), in which the capacitor has a three-dimensional metal insulation metal (MIM) structure.

(9) The imaging device according to any one of (1) to (8), in which the control unit turns on the first transistor and the second transistor in an entire period from a read operation of reading a pixel voltage of the first node to a shutter operation of the photoelectric conversion unit.

(10) The imaging device according to any one of (1) to (8), in which the control unit turns on the first transistor and the second transistor from a middle of a period from a read operation of reading a pixel voltage of the first node to a shutter operation of the photoelectric conversion unit.

(11) The imaging device according to any one of (1) to (8), in which the control unit intermittently turns on the first transistor and the second transistor in a period from a read operation of reading a pixel voltage of the first node to a shutter operation of the photoelectric conversion unit.

(12) An imaging device including:

a photoelectric conversion unit;

a first transistor having one end connected to the photoelectric conversion unit and the other end connected to a first node;

a second transistor having one end connected to the first node and the other end connected to a second node;

a third transistor having one end connected to the second node and the other end connected to a power supply ;

a capacitor connected to the second node; and

a control unit that controls driving of the first transistor, the second transistor, and the third transistor, in which

the control unit turns on the third transistor in at least a part of an accumulation period in the photoelectric conversion unit.

(13) The imaging device according to (12), in which the control unit turns on the first transistor and turns off the second transistor when turning on the third transistor in at least a part of the accumulation period in the photoelectric conversion unit.

(14) The imaging device according to (12) or (13), in which the capacitor is a high dielectric capacitor.

(15) The imaging device according to any one of (12) to (14), in which a gate voltage applied to the second transistor is variable.

(16) The imaging device according to any one of (12) to (15), further including a capacitor connected to the first node and not affected by dielectric absorption.

(17) The imaging device according to any one of (12) to (16), in which the first transistor is an embedded gate.

### REFERENCE SIGNS LIST

100 IMAGING DEVICE
101 Optical system
102 Solid-state imaging device
103 Imaging control unit
104 Image processing unit
105 Storage unit
106 Display unit
107 Operation unit
108 Bus
111 Pixel array unit
112 Vertical scanning circuit
113 Column read circuit
114 Column signal processing unit
115 Horizontal scanning circuit
116 Control circuit
PD1, PD2 Photodiode
122 Transfer transistor
123 Reset transistor
124 Amplification transistor
125 Selection transistor
126 Capacitor
127 Pass transistor
128 Switching transistor
FD1 to FD3 Floating diffusion
131 Horizontal drive line
132 Vertical signal line

1. An imaging device comprising:
a photoelectric conversion unit;
a capacitor having one end connected to the photoelectric conversion unit;
a first transistor having one end connected to the capacitor and the other end connected to a first node;
a second transistor having one end connected to the first node and the other end connected to a power supply; and
a control unit that controls driving of the first transistor and the second transistor, wherein
the control unit turns on the first transistor and the second transistor in at least a part of a period from a read operation of reading a pixel voltage of the first node to a shutter operation of the photoelectric conversion unit.

2. The imaging device according to claim 1, wherein the control unit controls a voltage applied to the capacitor so that a voltage is not applied to the capacitor before an accumulation period in which charge is accumulated in the photoelectric conversion unit.

3. The imaging device according to claim 1, wherein the capacitor is a high dielectric capacitor.

4. The imaging device according to claim 1, wherein the capacitor accumulates charge overflowing from the photoelectric conversion unit.

5. The imaging device according to claim 1, wherein the control unit reads a signal from the capacitor on a basis of double data sampling (DDS) driving.

6. The imaging device according to claim 1, wherein the other end of the capacitor is connected to a control power supply, and in an accumulation period, a potential of the control power supply is set to an intermediate potential lower than a potential of the power supply.

7. The imaging device according to claim 1, wherein:
the photoelectric conversion unit includes
a first photoelectric conversion unit, and
a second photoelectric conversion unit having lower sensitivity than the first photoelectric conversion unit; and
the capacitor accumulates charge overflowing from the second photoelectric conversion unit.

8. The imaging device according to claim 1, wherein the capacitor has a three-dimensional metal insulation metal (MIM) structure.

9. The imaging device according to claim 1, wherein the control unit turns on the first transistor and the second transistor in an entire period from a read operation of reading a pixel voltage of the first node to a shutter operation of the photoelectric conversion unit.

10. The imaging device according to claim 1, wherein the control unit turns on the first transistor and the second transistor from a middle of a period from a read operation of reading a pixel voltage of the first node to a shutter operation of the photoelectric conversion unit.

11. The imaging device according to claim 1, wherein the control unit intermittently turns on the first transistor and the second transistor in a period from a read operation of reading a pixel voltage of the first node to a shutter operation of the photoelectric conversion unit.

12. An imaging device comprising:
a photoelectric conversion unit;
a first transistor having one end connected to the photoelectric conversion unit and the other end connected to a first node;
a second transistor having one end connected to the first node and the other end connected to a second node;
a third transistor having one end connected to the second node and the other end connected to a power supply;
a capacitor connected to the second node; and
a control unit that controls driving of the first transistor, the second transistor, and the third transistor, wherein
the control unit turns on the third transistor in at least a part of an accumulation period in the photoelectric conversion unit.

13. The imaging device according to claim 12, wherein the control unit turns on the first transistor and turns off the second transistor when turning on the third transistor in at least a part of the accumulation period in the photoelectric conversion unit.

14. The imaging device according to claim 12, wherein the capacitor is a high dielectric capacitor.

15. The imaging device according to claim 12, wherein a gate voltage applied to the second transistor is variable.

16. The imaging device according to claim 12, further comprising a capacitor connected to the first node and not affected by dielectric absorption.

17. The imaging device according to claim 12, wherein the first transistor is an embedded gate.
